(19) United States
(12) Patent Application Publication
(10) Pub. No.: US 2003/0105701 A1
(43) Pub. Date: Jun. 5, 2003

(54) Apparatus and method for implementing and/or administering a wealth transfer plan

(76) Inventors: Michael D. Brown, Irvine, CA (US); Jonathan G. Blattmachr, Garden City, NY (US)

Correspondence Address: IRELL & MANELLA LLP, 840 NEWPORT CENTER DRIVE, SUITE 400, NEWPORT BEACH, CA, 92660, US

(21) Appl. No.: 10/125,914

(22) Filed: Apr. 18, 2002

Related U.S. Application Data
(60) Provisional application No. 60/337,758, filed on Dec. 3, 2001.

(51) Int. Cl. G06F 17/60

(52) U.S. Cl. 705/36

(57) ABSTRACT

An apparatus and method for the efficient transfer of wealth is disclosed. The method comprises a transferee securing an insurance policy having a death benefit component and a cash value component on the life of an insured. The death benefit proceeds are to be paid out at the death of the insured. A transferor obtains a loan having a principal and an interest. The principal of the loan is to be paid with the death benefit proceeds from the insurance policy. The proceeds from the loan are used to directly or indirectly obtain an income-generating investment instrument that produces periodic income. The periodic income is used to pay the interest of the loan. Rights to the death benefit component are allocated to the transferor and rights to the cash value component are allocated to a transferee. The insurance policy is funded directly or indirectly with proceeds from the loan as payment for rights to the death benefit component.

### CROSS-REFERENCE TO RELATED APPLICATIONS

The present application claims priority under 35 U.S.C. §119(e) to U.S. Provisional Patent Application Serial No. 60/337,758, filed Dec. 3, 2001, which is hereby incorporated by reference in its entirety.

### BACKGROUND OF THE INVENTION

1. Field of the Invention

The present disclosure relates in general to an apparatus and method for implementing and/or administering a wealth transfer plan. It more particularly relates to an apparatus and method for implementing and/or administering a plan that utilizes life insurance to transfer wealth from one party to another in a cost-effective manner.

2. Background Information

In estate planning, it has been found desirable to implement a plan that enables one to transfer wealth to others, such as to one's children, grandchildren, or other family members, in a cost-effective manner. Although numerous estate planning strategies have been implemented successfully in the past, many involve undesirable associated costs. For example, generation-skipping trusts have been shown to be useful instruments in conveying wealth from an individual to his or her heirs. However, considerable expenses may be incurred in connection with the funding of such trusts, such as the cost of liquidating assets at an undesirable time to fund the transfer, the diminution of the effective amount of the funding due to the tax burden imposed by estate or gift taxes, or other unwanted expenses.

Life insurance is another common tool used in estate planning. While there are many variations of life insurance, most policies fit in one of two categories: “term life insurance” and “permanent life insurance.” Term life insurance is the most basic kind of life insurance. It pays a predetermined sum to a designated beneficiary if the insured's death occurs during a specified period of time (i.e., the term of the insurance policy). Where an insured purchases and owns a policy until death, however, the value of the policy may be included in the taxable estate of the insured, thereby decreasing the effective amount of the wealth transferred. One way to avoid the inclusion of the value of the policy in the taxable estate of the insured is to utilize an irrevocable trust as the owner and beneficiary of the policy. This approach, however, may result in the imposition of a gift tax on funds transferred to the trust for the purpose of funding the policy, subject to any gift tax credits or annual exclusions available to the insured. Permanent life insurance, on the other hand, separates the values and benefits of a single policy into two components: the cash value component and the death benefit component. This characteristic enables two different entities to share, or “split,” the premiums, cash value, death benefit, and/or ownership of a single policy. Such shared policies have become known in the insurance industry as “split-dollar” insurance, and are typically used to provide fringe benefits in an employer-employee context. Hence, “split-dollar” insurance is not a type of insurance, but rather is a way of funding permanent life insurance.

In a “classic” split-dollar arrangement between a corporation and its employee, a life insurance policy is obtained on the employee's life. In many cases, the corporation purchases a policy on the employee's life and pays the associated premiums. The employee, as the insured, then reimburses the corporation for an amount equal to the annual term cost of the life insurance policy. Under such an arrangement, the employee obtains the right to name the beneficiary to the death benefit component of the policy, and the corporation retains the right over the cash value component of the policy. One purpose of such an arrangement is to combine the insurance needs of the employee with the often superior premium paying ability of the corporation.

This split-dollar arrangement can also be used in the “private” context, such as between a trust and its grantor. In a “private” split-dollar arrangement, the trust purchases a policy on the grantor's life and pays its premiums. The grantor, as the insured, then reimburses the trust for an amount equal to the annual term cost of the life insurance policy. Under such an arrangement, the grantor obtains the right to name the beneficiary to the death benefit component of the policy, and the trust retains the right over the cash value component of the policy. Unlike in the corporation-employee context, however, the trust (or the grantor) may in some cases lack sufficient liquidity to make large potential payments necessary to cover the annual term cost of the life insurance policy. For instance, a grantor whose wealth is primarily locked in a partnership may have difficulty liquidating his or her interest in the partnership in order to fund the life insurance policy. Hence, a wealth transfer plan that is cost-effective and requires a relatively small amount of liquidity would be desirable.

### SUMMARY OF THE INVENTION

An apparatus and method for the efficient transfer of wealth is disclosed. The method comprises a transferee securing an insurance policy having a death benefit component and a cash value component on the life of an insured. The death benefit proceeds are to be paid out at the death of the insured. A transferor obtains a loan having a principal and an interest. The principal of the loan is to be paid with the death benefit proceeds from the insurance policy. The proceeds from the loan are used to directly or indirectly obtain an income-generating investment instrument that produces periodic income. The periodic income is used to pay the interest of the loan. Rights to the death benefit component are allocated to the transferor and rights to the cash value component are allocated to a transferee. The insurance policy is funded directly or indirectly with proceeds from the loan as payment for rights to the death benefit component.

Other embodiments are disclosed and claimed herein.

### DESCRIPTION OF THE DRAWINGS

FIG. 1 is a flow chart of a method for implementing and/or administering one aspect of a wealth transfer plan.

FIG. 2 is a block diagram of a system for implementing and/or administering one aspect of a wealth transfer plan.

FIG. 3 illustrates the state of the system of FIG. 2 upon termination of the split-dollar agreement.

FIG. 4 illustrates the state of the system of FIG. 2 if the insured dies after termination of the split-dollar agreement.

FIG. 5 illustrates the state of the system of FIG. 2 if the insured dies before termination of the split-dollar agreement.

FIG. 6 is a flow chart depicting a method for implementing and/or administering one aspect of a wealth transfer plan involving loan financing.

FIG. 7 is a block diagram of a system for implementing and/or administering one aspect of a wealth transfer plan involving loan financing.

FIG. 8 illustrates the state of the system of FIG. 7 upon termination of the split-dollar agreement.

FIG. 9 illustrates the state of the system of FIG. 7 if the insured dies after termination of the split-dollar agreement.

FIG. 10 illustrates the state of the system of FIG. 7 if the insured dies before termination of the split-dollar agreement.

FIG. 11 is a flow chart depicting a method for implementing and/or administering one aspect of a wealth transfer plan involving loan financing and SPIA financing.

FIG. 12 is a block diagram of a system for implementing and/or administering one aspect of a wealth transfer plan involving loan financing and SPIA financing.

FIG. 13 illustrates the state of the system of FIG. 12 upon termination of the split-dollar agreement.

FIG. 14 illustrates the state of the system of FIG. 12 if the insured dies after termination of the split-dollar agreement.

FIG. 15 illustrates the state of the system of FIG. 12 if the insured dies before termination of the split-dollar agreement.

FIG. 16 is a block diagram of a system for implementing and/or administering one aspect of a wealth transfer plan involving a lifetime transfer of assets in exchange for a note.

FIG. 17 is a block diagram of a system for implementing and/or administering one aspect of a wealth transfer plan involving a reduction of death benefit to facilitate the transfer of assets.

FIG. 18 is a block diagram of a system for implementing and/or administering one aspect of a wealth transfer plan involving a reduction of death benefit in multiple policies to facilitate the transfer of assets.

FIG. 19 is a flow chart depicting a method according to which a life insurance policy may be funded indirectly with proceeds from a loan.

FIG. 20 is a block diagram of an exemplary embodiment of a computer that may be used to implement one or more embodiments herein.

FIG. 21 is a flow chart depicting a method according to which an application program may compute data to generate outputs for the implementation and/or administration of a wealth transfer plan.

### DETAILED DESCRIPTION

While the present disclosure is open to various modifications and alternative constructions, the embodiments shown in the drawings will be described herein in detail. It is to be understood, however, that there is no intention to limit the invention to the particular embodiments disclosed. On the contrary, the intention is to cover all modifications, equivalents, and alternative constructions falling within the spirit and scope of the invention as expressed in the appended claims. It should also be noted that although the steps in certain figures set forth herein are shown in order of intended implementation, those of ordinary skill in the art should recognize that the steps in some cases may be rearranged or performed simultaneously.

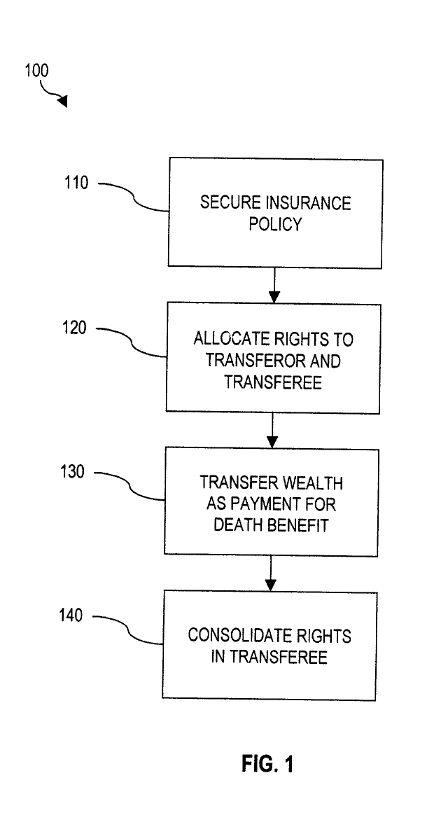

Referring to the drawings, FIG. 1 is a flow chart of a method for implementing and/or administering one aspect of a wealth transfer plan. As illustrated in FIG. 1, method 100 includes securing an insurance policy on the life of an insured individual, where the policy includes a death benefit component and a cash value component (block 110); allocating rights to the death benefit component of the policy (e.g., the right to name the beneficiary of the death benefit component) to the transferor and allocating rights to the cash value component of the policy to the transferee (block 120); transferring wealth from the transferor to the transferee as rent payment for the death benefit component (block 130); and consolidating the rights to the policy in the transferee such that after consolidation, the transferee possesses the rights to the death benefit component and the cash value component of the policy (block 140).

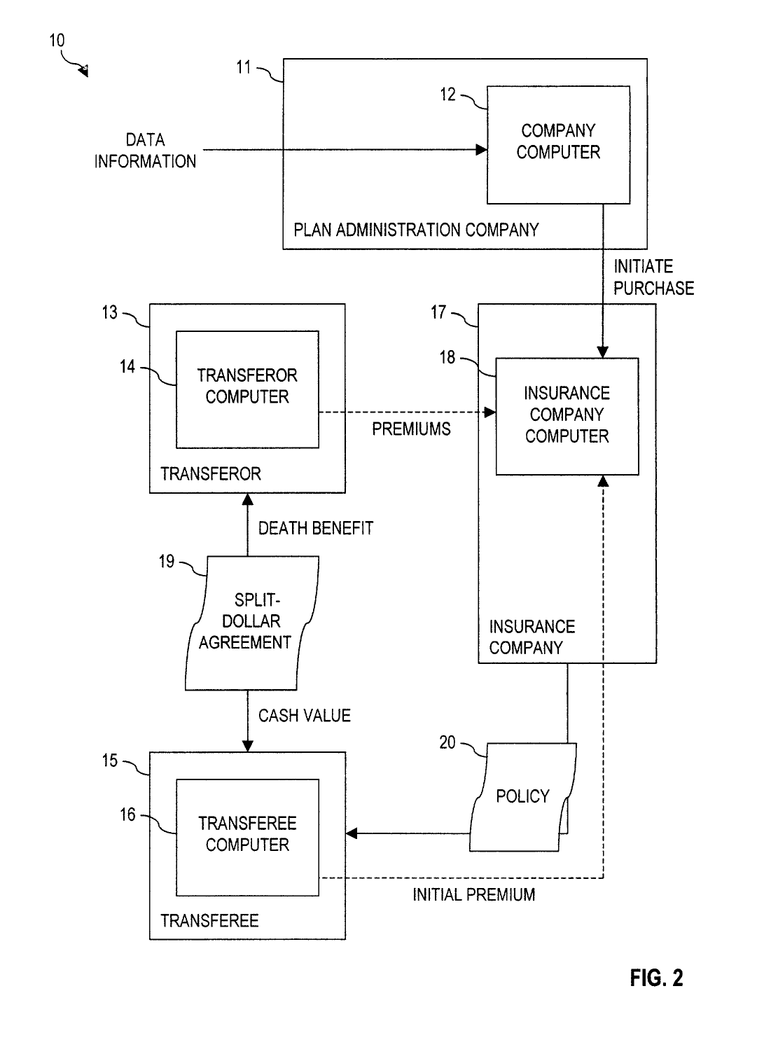

Referring to FIG. 2, there is shown a block diagram of a system 10 corresponding to method 100 for implementing and/or administering one aspect of a wealth transfer plan by a plan administration company 11 employing a company computer 12. The system 10 may be used to transfer wealth from a transferor 13, having a transferor computer 14, to a transferee 15, having a transferee computer 16. In one embodiment, the transferor 13 may be an individual and the transferee 15 may be a generation-skipping trust created for one or more of the individual's descendants. Without limitation, the transferor 13 may also include one or more individuals, entities, trusts, corporations, partnerships, entities possessing wealth to be transferred, or any combination of the above. Similarly without limitation, the transferee 15 may include one or more individuals, entities, trust, corporations, partnerships, entities to which wealth can be transferred, or any combination of the above.

Personal data are gathered and entered into the company computer 12 to facilitate implementation and subsequent administration of the plan. This data may comprise demographic and financial information of a potential insured individual including, but not limited to, gender, age, health, location, family history, risk factors, net worth, assets, liabilities, and equity.

The transferee 15 secures at least one insurance policy 20 issued by an insurance company 17, which may have an insurance company computer 18. Without limitation, the insured may include the transferor 13, a third party, one or more individuals, or any combination of the above. The insurance policy 20 may include a cash value policy such as universal life, variable universal life, whole life, survivorship life, private placement or any other insurance policy that may be used with a split-dollar agreement. The insurance policy 20 may require a single, one-time premium payment or multiple premium payments made over time. In one embodiment, the plan administration company 11 may initiate the purchase of the insurance policy by notifying the insurance company of transferee's interest in such a purchase, and the transferee 15 may secure the policy 20 by funding the initial premium with existing funds. However, without limitation, the purchase of the insurance policy 20 may be initiated by the plan administration company 11 on behalf of the purchaser of the policy, by a third party on behalf of the purchaser of the policy, or directly by the purchaser of the policy. Furthermore, the transferee 15 may secure the policy 20 by any means, including but not limited to funding the initial premium with existing or borrowed funds, acquiring the policy from the transferor 13 or a third party through a taxable transfer or gift, or purchasing the policy from the transferor 13 or a third party.

The transferor 13 and the transferee 15 may enter into a split-dollar agreement 19, which may be effectuated according to the advisement of the plan administration company 11. The split-dollar agreement 19 may be structured to allocate the rights to the cash value component to the transferee 15 and the rights to the death benefit component to the transferor 13 for the period of the split-dollar agreement 19. The cash value component and the death benefit component may be defined respectively in the split-dollar agreement in any number of ways. In one embodiment, the cash value component may simply be defined as the cash value of the policy (i.e., the cash or investment component of the policy), or any specified amount thereof. In another embodiment, the cash value component may be defined as the greater of the cash value in the policy or the total amount of premiums paid. Likewise, the death benefit component may simply be defined as the gross death benefit (i.e., the face value of the policy), or any portion thereof such as a specified amount of the death benefit, the gross death benefit minus cash value (i.e., the net amount at risk for the insurance company), the net death benefit (i.e., the gross death benefit minus an amount corresponding to the cash value component), or any other amounts related to but not exceeding the face value of the policy. One of ordinary skill in the art should appreciate that a tailored definition of the cash value component and the death benefit component in the split-dollar agreement enables the wealth transfer plan to be customized according to the particular needs, preferences, and risk tolerances of the parties involved, and to comply with relevant government regulations.

In accordance with the split-dollar agreement 19, the transferor 13 may pay periodic rent for the value of the death benefit component as calculated using life insurance valuation tables set forth in the split-dollar agreement 19. Such tables may include but are not limited to Table P.S. 58, Table U.S. 38, Insurance Carrier 66-110 Tables, Section 79, or other life insurance valuation tables. In one embodiment, as shown in FIG. 2, the transferor 13 may pay rent by making premium payments directly to the insurance company 17 on behalf of the transferee 15. To this end, the transferor 13 or the transferor computer 14 may transmit a message with a fund transfer as premiums to the insurance company computer 18. In another embodiment, the transferor 13 may make payments pursuant to the split-dollar agreement 19 directly to the transferee 15, and the transferee 15 may then in turn use the proceeds to make premium payments to the insurance company 17. To this end, the transferor 13 or the transferor computer 14 may transmit a message with a fund transfer to the transferee computer 16, and then the transferee 15 or the transferee computer 16 may transmit a message with a fund transfer as premiums to the insurance company computer 18. It should be appreciated by one of ordinary skill in the art that while the above embodiments disclose payment made to either the insurance company 17 or the transferee 15, payment may also be made to third parties or to any combination of the above. It should also be understood that the transmission of any message or fund transfer may be made or delivered by hand, courier, telephone, facsimile, email, postal delivery, or any other suitable means used for such purposes.

When the transferor 13 has paid enough rent payments so as to sufficiently fund the policy 20 for the life of the insured, the split-dollar agreement 19 may be terminated. To this end, the company computer 12 may transmit a message to the transferor 13 or to the transferee 15 with instructions to terminate the split-dollar agreement 19. Once the agreement is terminated, the transferor 13 may no longer be entitled to the death benefit component or have any ownership rights in the policy 20. Therefore, after a period of time of leasing the death benefit component of the policy to the transferor 13, the transferee 15 may secure rights to both the cash value component and the death benefit component of the policy 20.

It should be appreciated by one of ordinary skill in the art that in the above aspect of a wealth transfer plan, the value of the death benefit component for a given period of time based on the insurance valuation tables may be higher than the actual cost of the policy 20. Consequently, when the transferor 13 transfers wealth in exchange for the rights to the death benefit component for a given period of time, the amount transferred may be sufficient to fund the policy 20 for a much longer period. As an example, where the insured is a 75-year old female, the value of a $10 million death benefit for a period of five years may be as much as $3.1 million, according to Table P.S. 58. However, $3.1 million may actually be enough to fund the policy for a real period of twenty-five years. So after only five years of rental of its death benefit component, the policy 20 may be funded enough that the split-dollar agreement may be terminated. Moreover, if equal value is regarded to have been exchanged when the transferor 13 pays the transferee 15 for the rights to the death benefit component, there may be minimal transfer tax liability. The end result in the above example is that the transferee 15 may obtain a sufficiently funded policy 20 having a $10 million death benefit component at minimal cost on its part and with minimal tax consequences to the transferor 13. It follows that by selecting life insurance valuation tables with higher rates or insuring individuals requiring lower actual costs of insurance, a transferor 13 may be able to transfer the same amount of wealth in a shorter period of time, or conversely, to transfer more wealth in a same period of time.

It should be appreciated that the above example is merely provided as an illustration, and should in no way be construed to limit the scope of the disclosure. For instance, one of ordinary skill should understand that the transferor 13 need not be limited to transferring a sufficient amount to fund the policy 20. Instead, the transferor 13 may transfer more or less wealth depending on the objectives of a particular wealth transfer plan or the risk tolerance of the parties involved. It should also be understood that while the disclosed embodiments accomplish the consolidation of rights to the policy 20 in the transferee 15 through termination of the split-dollar agreement 19, there are many alternative ways to consolidate the rights including, but not limited to, the execution of a separate agreement, the inclusion of a provision in the split-dollar agreement 19 itself, a formal modification of the original agreement, allowing the split-dollar agreement to lapse, and the like. It should further be understood that while the role of the plan administration company 11 in the disclosed embodiments is primarily one of advising the various parties and initiating the respective transactions, there are many alternative ways for the plan administration company 11 to assist the transferor 13 or transferee 15 in the implementation and/or administration of the wealth transfer plan including, but not limited to, computing financial data, creating illustrations, drafting documents and agreements, completing application forms, facilitating the transfer of funds, conducting negotiations, providing instruction and advice, and the like. It should also be understood that while the implementation and administration of the wealth transfer plan are conducted by the same entity in the disclosed embodiments, one of ordinary skill in the art should recognize that the implementation and administration of the wealth transfer plan may also be conducted by separate entities.

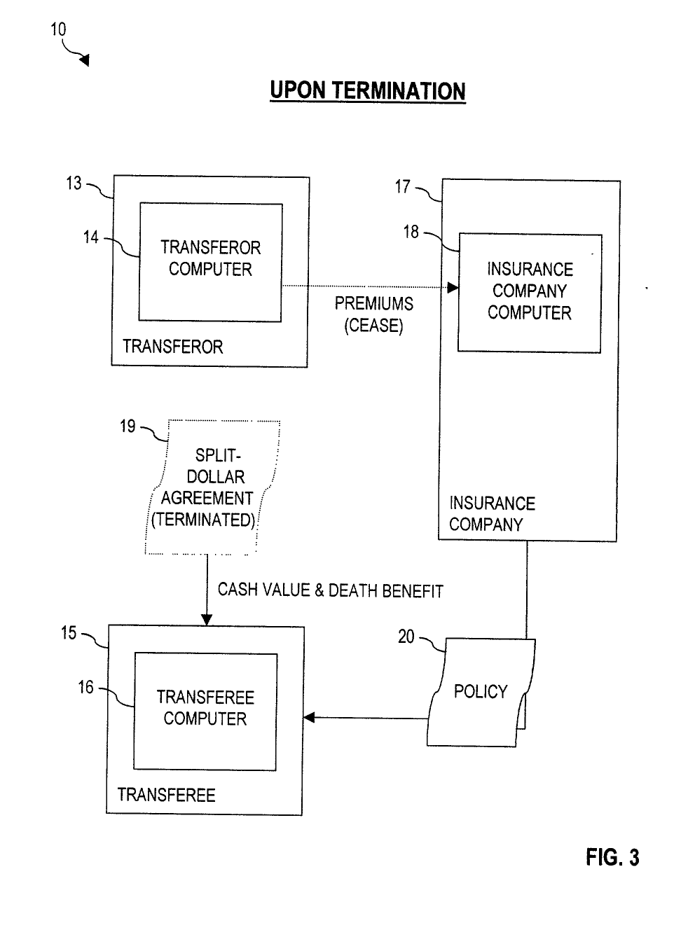

FIG. 3 illustrates the state of the system of FIG. 2 upon termination of the split-dollar agreement. As shown in FIG. 3, any right that the transferor 13 may have possessed with respect to the insurance policy during the split-dollar agreement 19 is terminated. Hence, the transferor 13 may cease making rent payments, and the transferee 15 may secure rights to both the cash value component and the death benefit component of the policy 20. If the policy 20 is sufficiently funded, as disclosed in one embodiment above, prior to the termination of the split-dollar agreement, no further premium payments would be necessary. However, if circumstances require that the split-dollar agreement be terminated before the policy 20 is sufficiently funded, the transferee 15 may be required to supply additional funds for the policy 20 to avoid its expiration before the death of the insured.

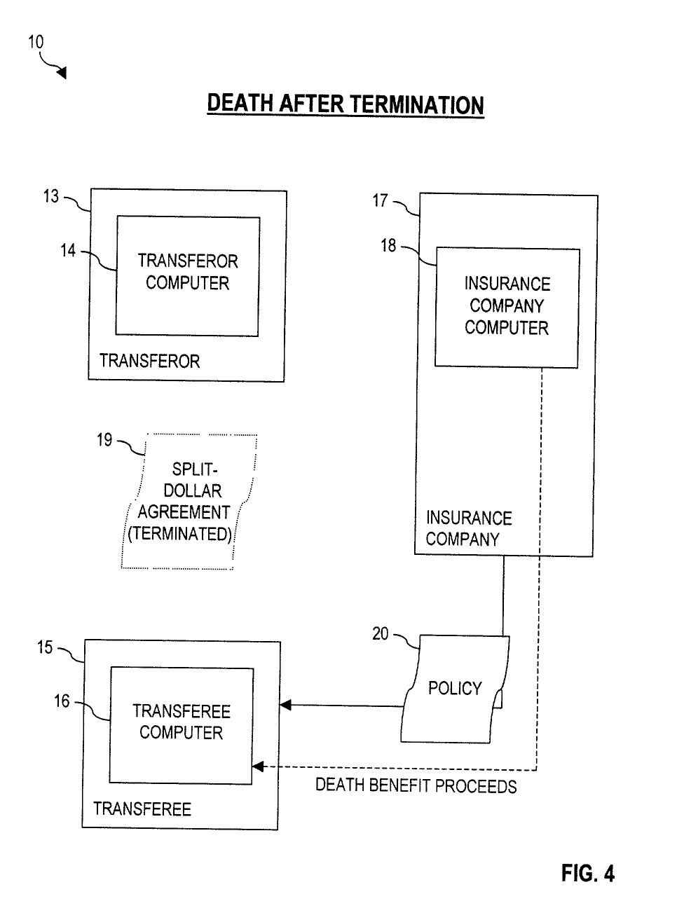

FIG. 4 illustrates the state of the system of FIG. 2 if the insured dies after termination of the split-dollar agreement and the policy 20 is retained until the death of the insured. As shown in FIG. 4, since the transferee 15 possesses the rights to both the cash value component and the death benefit component of the policy, then the death benefit proceeds may be paid to the transferee 15 (or, if applicable, to a beneficiary designated by the transferee 15) upon the death of the insured. In another embodiment, after the termination of the split-dollar agreement 19 but prior to the death of the insured, the transferee 15 may cancel the policy, thereby benefiting from the distribution of the cash value in the policy. This pre-death withdrawal or distribution of the cash value may be also used in all other embodiments disclosed hereinafter.

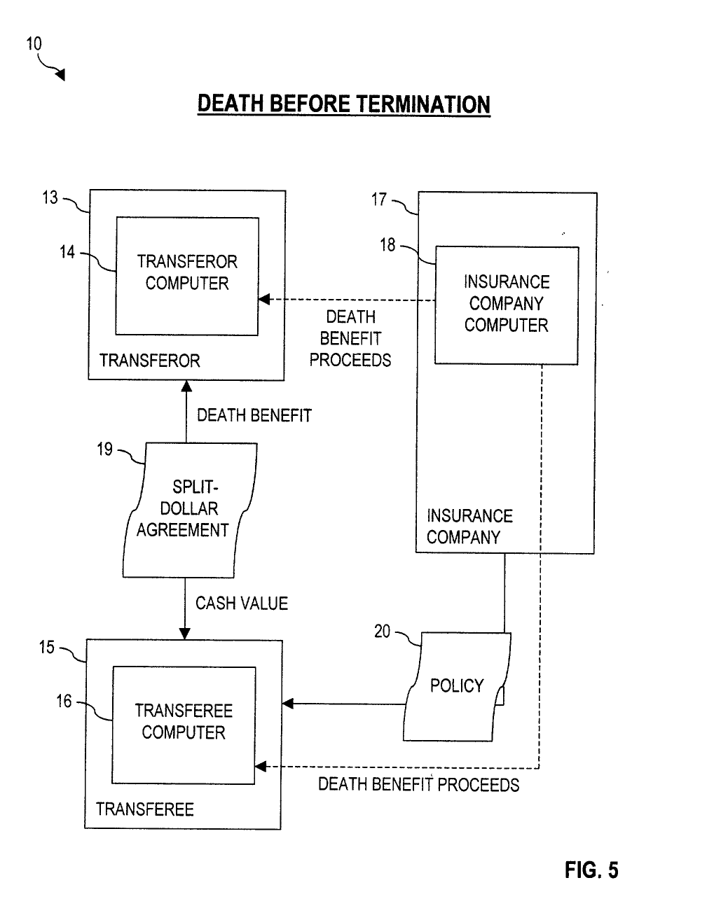

FIG. 5 illustrates the state of the system of FIG. 2 if the insured dies before termination of the split-dollar agreement. As shown in FIG. 5, upon the death of the insured, a portion of the death benefit proceeds may be paid to the transferor 13 or the transferor's estate (in the case where the transferor 13 is the insured) in an amount corresponding to the death benefit component of the policy 20 as specified in the split-dollar agreement 19. Likewise, a portion of the death benefit proceeds may be paid to the transferee 15 in an amount corresponding to the cash value component of the policy 20 as specified in the split-dollar agreement 19. Although an early death may give the transferor 13 or the transferor's estate a financial windfall of death benefit proceeds that may be free of income tax, death benefit proceeds may nevertheless be includable in the transferor's estate for federal estate tax purposes.

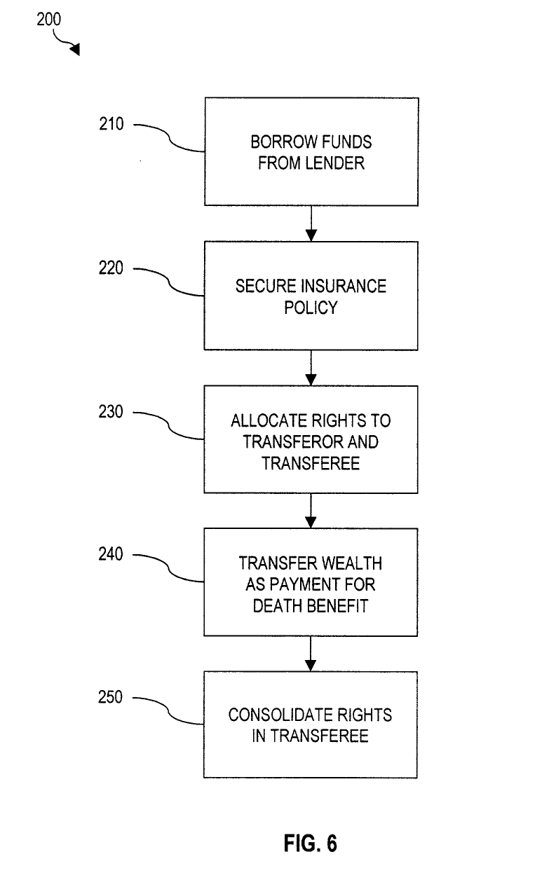

While the above combination of a life insurance policy and a split-dollar agreement may facilitate the transfer of wealth in a cost-effective manner, a prospective transferor may face a situation where sufficient liquidity is not available to cover an adequate portion of the rent payments. In such a case, the transferor 13 may desire to finance all or part of the rent payments. As illustrated in FIG. 6, there is shown a flow chart depicting a method 200 for implementing and/or administering one aspect of a wealth transfer plan involving loan financing. The method 200 includes borrowing sufficient funds from a lender to cover at least a portion of the rent payment (block 210); securing an insurance policy on the life of an insured individual, where the policy includes a cash value component and a death benefit component (block 220); allocating rights to the death benefit component of the policy to the transferor and allocating rights to the cash value component of the policy to the transferee (block 230); transferring wealth from the transferor to the transferee as rent payment for the death benefit component (block 240); and consolidating the rights to the policy in the transferee such that after consolidation, the transferee possesses the rights to the death benefit component and the cash value component of the policy (block 250).

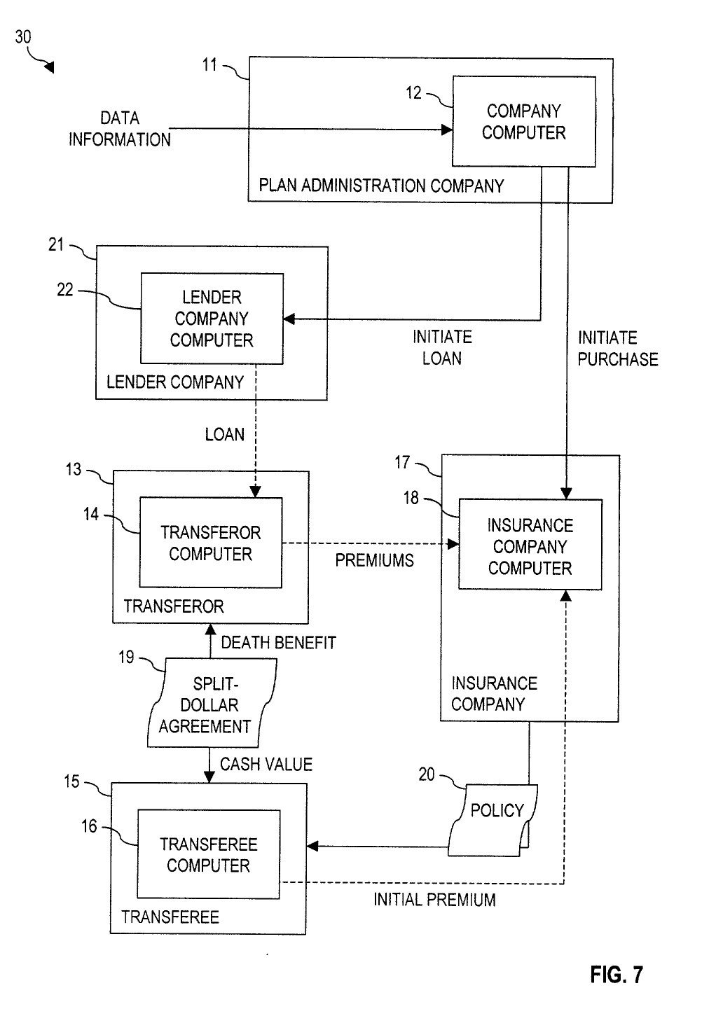

FIG. 7 is a block diagram of a system 30 for implementing and/or administering one aspect of a wealth transfer plan involving loan financing. Referring to FIG. 7, the transferor 13 may acquire funds for making all or part of the rent payments in cash by obtaining a loan from a lender company 21 having a lender company computer 22. In some cases, this loan may be a non-callable, interest-only loan where the borrower pays the interest during his or her lifetime, and pays the principal upon death or cancellation of the policy 20. In one embodiment, the company computer 12 may transmit a message to the lender company computer 22 requesting the loan, and the lender company computer 22 may then transmit a message with a fund transfer as the loan to the transferor computer 14. However, without limitation, the securing of the loan may be initiated by the plan administration company 11 on behalf of the transferor 13, by a third party on behalf of the transferor 13, or directly by the transferor 13. Once the loan is secured, the transferor 13 may be responsible for both the interest and any outstanding principal owed to the lender company 21. Furthermore, it should be understood by one of ordinary skill in the art that loan financing may be used to simply fund any of the above life insurance policies, irrespective of the particular implementations of the disclosed embodiments.

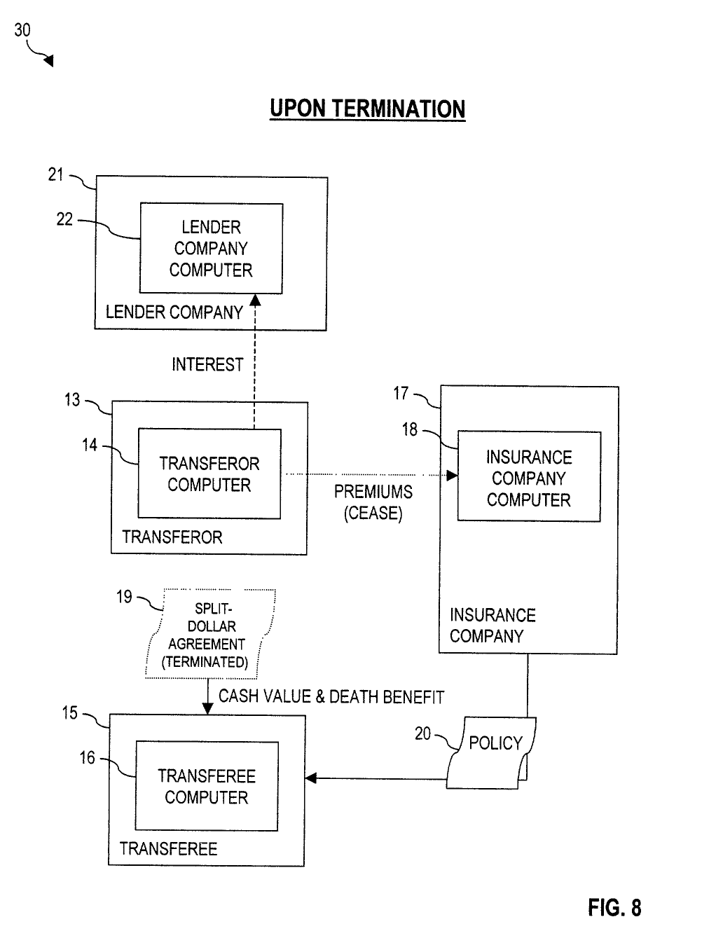

FIG. 8 illustrates the state of the system of FIG. 7 upon termination of the split-dollar agreement. As shown in FIG. 8, any right that the transferor 13 may have possessed with respect to the insurance policy during the split-dollar agreement 19 is terminated. Hence, the transferor 13 may cease making rent payments, and the transferee 15 may secure rights to both the cash value component and the death benefit component of the policy 20. If the policy 20 is sufficiently funded prior to the termination of the split-dollar agreement, no further premium payments would be necessary. So long as the loan is still outstanding, though, the transferor 13 may be required to continue making interest payments to the lender company 21 as well as retain its general obligation with respect to the principal.

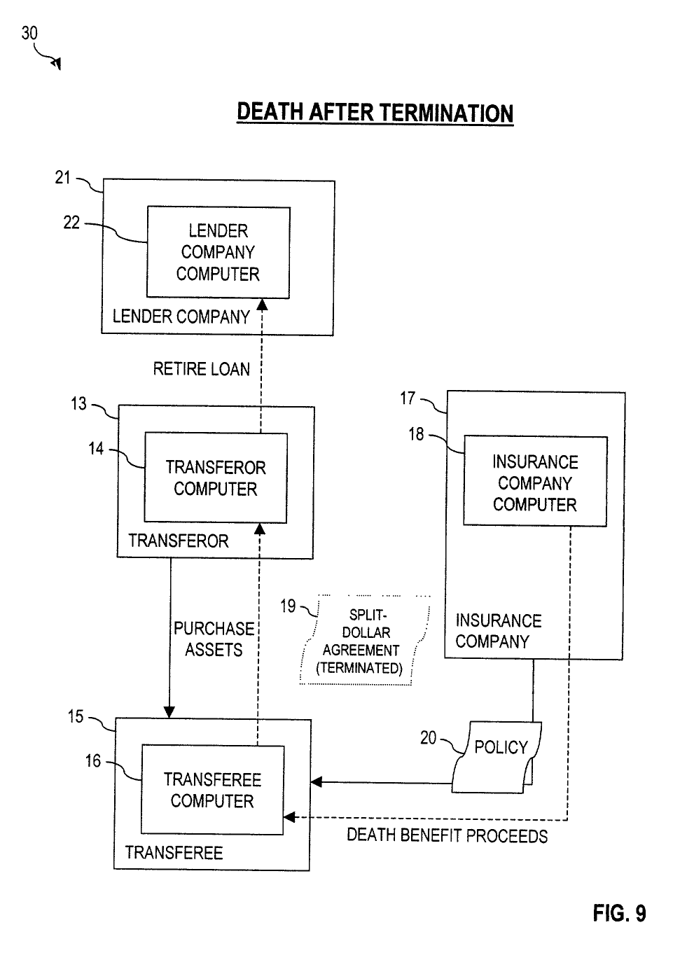

FIG. 9 illustrates the state of the system of FIG. 7 if the insured dies after termination of the split-dollar agreement 19 and the policy 20 is retained until the death of the insured. As shown in FIG. 9, upon the death of the insured, death benefit proceeds may be paid to the transferee 15. In the case where the transferor 13 is the insured, the transferee 15 may use a portion of the insurance proceeds to purchase assets from the estate of the transferor 13. The estate of the transferor 13 may then retire any outstanding loans to the lender company 21 with the proceeds from the sale of assets. It should be appreciated that the sale of estate assets is advantageous in that it allows the estate to transfer assets to intended recipients as well as provide liquid proceeds to retire debts and pay taxes. It should also be appreciated that an advantage of any debt remaining in the estate at death from the loan reduces the value of the estate, thus reducing the amount of estate tax liability.

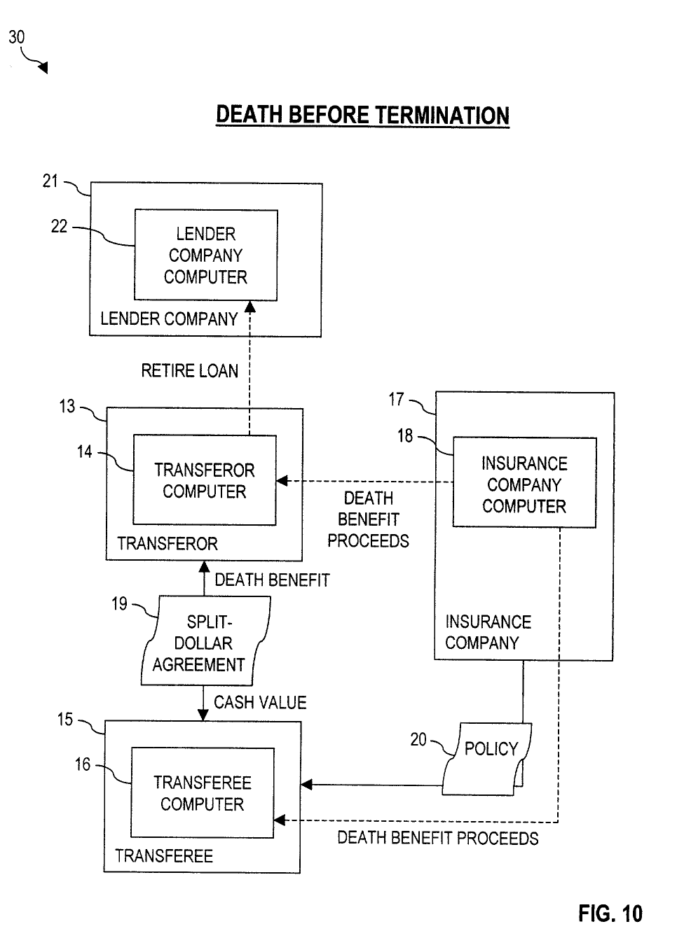

FIG. 10 illustrates the state of the system of FIG. 7 if the insured dies before termination of the split-dollar agreement 19. As shown in FIG. 10, upon the death of the insured, a portion of the death benefit proceeds may be paid to the transferor 13 or the transferor's estate in an amount corresponding to the death benefit component of the policy 20 as specified in the split-dollar agreement 19. Likewise, a portion of the death benefit proceeds may be paid to the transferee 15 in an amount corresponding to the cash value component of the policy 20 as specified in the split-dollar agreement 19. The death benefit proceeds received by the transferor 13 or the transferor's estate may be used to retire any outstanding loans to the lender company 21. Although an early death may give the transferor 13 or the transferor's estate a financial windfall of death benefit proceeds that may be free of income tax, death benefit proceeds may nevertheless be includable in the transferor's estate for federal estate tax purposes.

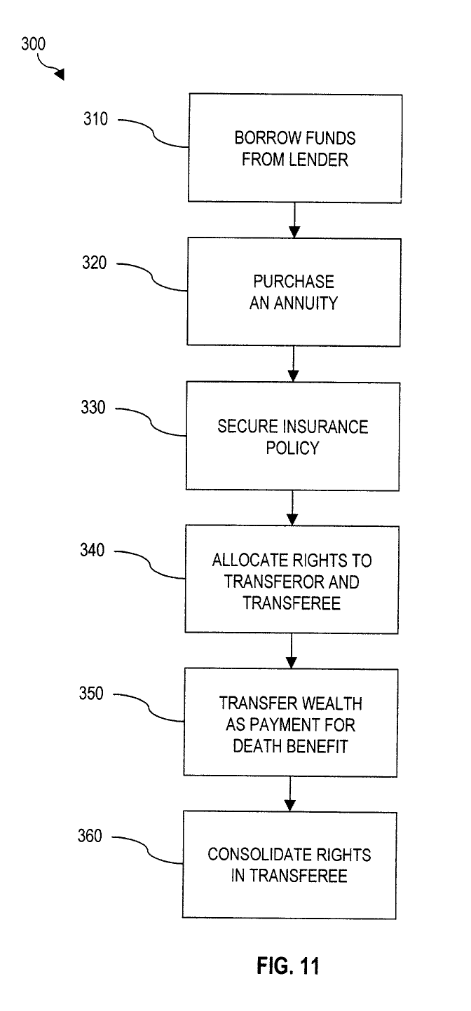

While loan financing may reduce the amount of liquidity necessary to cover rent payment, the amount of interest incurred each year on the loan may still be undesirably high. The transferor 13 may reduce the out-of-pocket cost of interest by using some of the loan proceeds to invest in an income-generating investment instrument. One such instrument may be a single premium immediate annuity (SPIA), offered by investment products providers such as capital or insurance companies. The SPIA would generate periodic income that may be applied toward all or part of the interest payment for the loan. Hence, as shown in FIG. 11, there is shown a flow chart depicting one embodiment of a method 300 for implementing and/or administering a wealth transfer plan involving a loan for financing rent payments and a SPIA for t0 financing interest payments. The method 300 includes borrowing sufficient funds from a lender to cover at least a portion of the rent payment and to purchase an annuity (block 310); purchasing an annuity, where the annuity provides a periodic benefit (block 320); securing an insurance policy on the life of an insured individual, where the policy includes a cash value component and a death benefit component (block 330); allocating rights to the death benefit component of the policy to the transferor and allocating rights to the cash value component of the policy to the transferee (block 340); transferring wealth from the transferor to the transferee as rent payment for the death benefit component (block 350); and consolidating the rights to the policy in the transferee such that after consolidation, the transferee possesses the rights to the death benefit component and the cash value component of the policy (block 360).

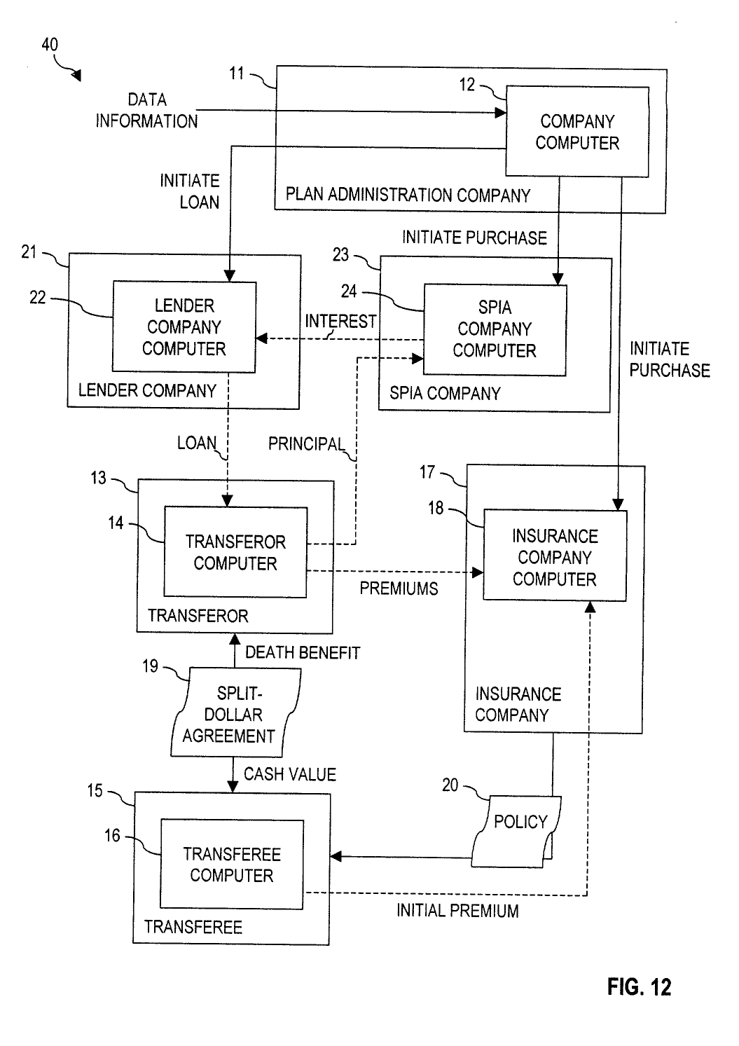

FIG. 12 is a block diagram of a system 40 for implementing and/or administering one aspect of a wealth transfer plan involving a loan for financing rent payments and a SPIA for financing interest payments. Referring to FIG. 12, the transferor 13 may borrow additional money from a lender company 21 to purchase a SPIA from a SPIA company 23 having a SPIA company computer 23. In one embodiment, the company computer 12 may transmit a message to the SPIA company computer 23 to initiate the SPIA purchase. However, without limitation, the purchase of the SPIA may be initiated by the plan administration company 11 on behalf of the transferor 13, by a third party on behalf of the transferor 13, or directly by the transferor 13. In one embodiment, payment of the premium to the SPIA company 23 may be made by the transferor 13 transmitting a message with a fund transfer from the transferor computer 14 to the SPIA company computer 23. However, payment to the SPIA company 23 may be made by others including, but not limited to, the lender company 21, the transferee 15, or a third party. When the SPIA company computer 23 receives the payment, it may then generate periodic income and transmit a message with a fund transfer to the lender company 21 as interest payment for the loan. However, the periodic income generated by the SPIA company 23 may be paid to others including, but not limited to, the transferor 13 or a third party. It should be understood that the periodic income generated by the SPIA company 23 may be paid monthly, annually, or otherwise, for the life of the insured. It should also be understood that, if properly structured, the periodic income generated by the SPIA company 23 may be sufficient to cover the entire interest payment for the loan. In some circumstances, such as when large premiums are paid for the SPIA, the periodic income generated by the SPIA company 23 may be sufficient to generate positive cash flow, which the transferor 13 may use to make its rent payments for the right to the death benefit component, use to make premium payments for the insurance policy, simply keep as taxable income and return of capital, contribute as a deductible gift to charity, or otherwise dispose of as desired. Furthermore, while the above description specifically discloses the use of a SPIA for financing interest, one of ordinary skill in the art should understand that other income-generating investment instruments may be used, such as annuity contracts, municipal bonds, derivatives (e.g., stock collars that produce positive cash flow), and other products that generate sufficient periodic income from the invested loan proceeds for effective use in the disclosed embodiments.

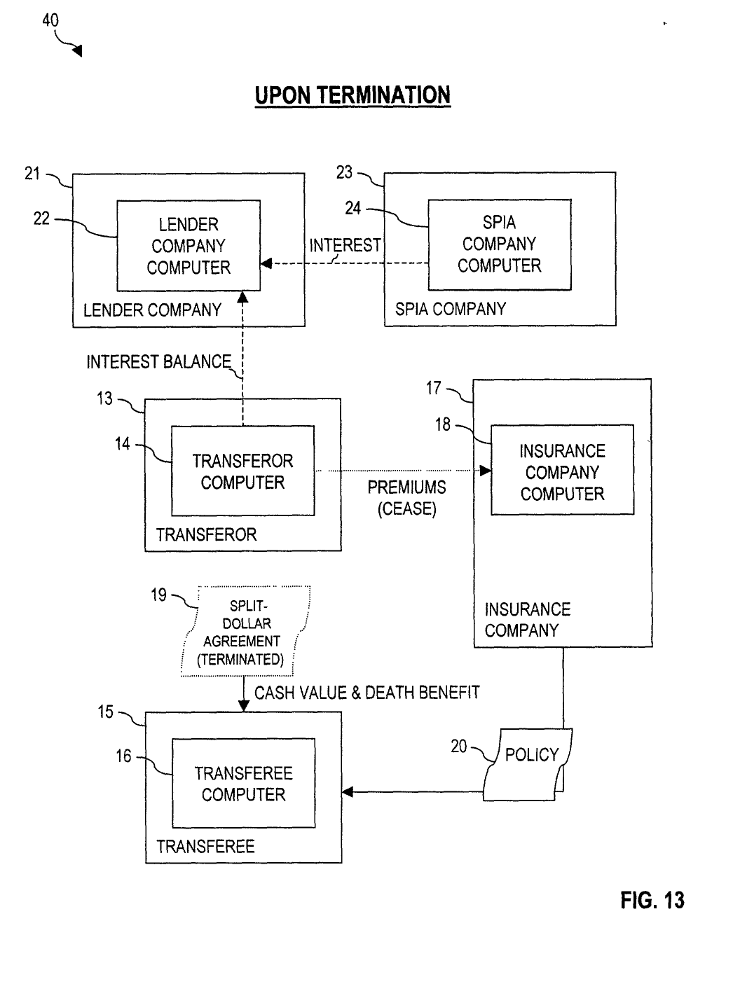

FIG. 13 illustrates the state of the system of FIG. 12 upon termination of the split-dollar agreement. As shown in FIG. 13, any right that the transferor 13 may have possessed with respect to the insurance policy during the split-dollar agreement 19 is terminated. Hence, the transferor 13 may cease making rent payments, and the transferee 15 may secure rights to both the cash value component and the death benefit component of the policy 20. If the policy 20 is sufficiently funded prior to the termination of the split-dollar agreement, no further premium payments would be necessary. The SPIA company 23 may continue to generate periodic income and transmit interest payment for the loan to lender company computer 22. So long as the loan is still outstanding, though, the transferor 13 may remain responsible for any outstanding balance of the interest owed to the lender company 21, and retain its general obligation with respect to the principal.

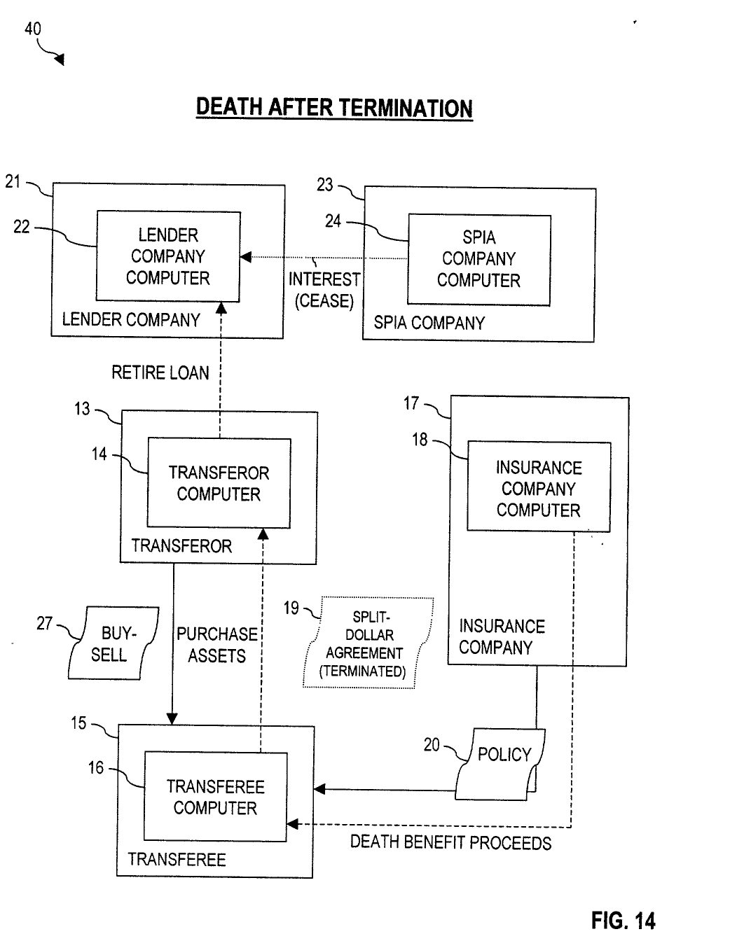

FIG. 14 illustrates the state of the system of FIG. 12 if the insured dies after termination of the split-dollar agreement and the policy 20 is retained until the death of the insured. As shown in FIG. 14, upon the death of the insured, death benefit proceeds may be paid to the transferee 15, and the SPIA company 23 may cease generating periodic income as interest payment for the loan. Furthermore, in the case where the transferor 13 is the insured, the transferee 15 may use a portion of the death benefit proceeds to purchase assets from the estate of the transferor 13. The estate of the transferor 13 may use the proceeds from the sale of assets to retire any outstanding loans to the lender company 21. In addition to the advantages already mentioned with respect to other embodiments, it should be appreciated that while the net benefit of the strategy at death may be reduced due to the debt created by financing the SPIA purchase, the use of a SPIA may enable the transferor 13 to significantly reduce the out-of-pocket cash flow during his or her lifetime.

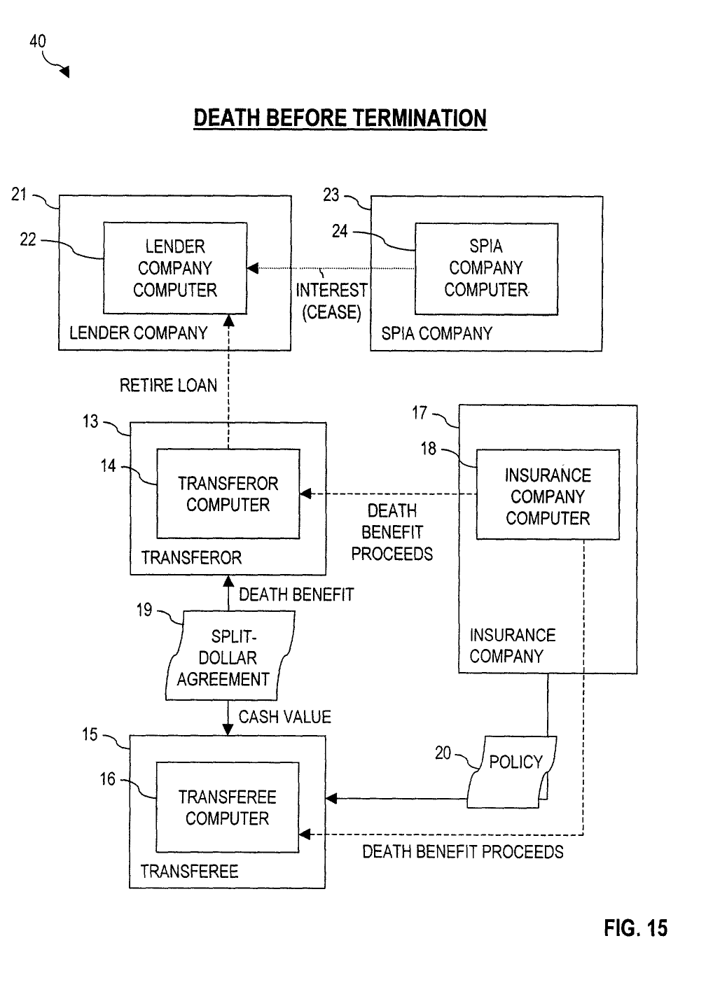

FIG. 15 illustrates the state of the system of FIG. 12 if the insured dies before termination of the split-dollar agreement. As shown in FIG. 15, upon the death of the insured, the SPIA company 23 may cease generating periodic income as interest payment for the loan, and a portion of the death benefit proceeds may be paid to the transferor 13 or the transferor's estate in an amount corresponding to the death benefit component of the policy 20 as specified in the split-dollar agreement 19. Likewise, a portion of the death benefit proceeds may be paid to the transferee 15 in an amount corresponding to the cash value component of the policy 20 as specified in the split-dollar agreement 19. The death benefit proceeds received by the transferor 13 may be used to retire any outstanding loans to the lender company 21. Although an early death may give the transferor 13 or the transferor's estate a financial windfall of death benefit proceeds that may be free of income tax, death benefit proceeds may nevertheless be includable in the transferor's estate for federal estate tax purposes.

In order to successfully obtain the loan in the above embodiments, the transferor 13 may be required by the lender company 21 to pledge collateral to secure the loan. Typically, the transferor 13 may pledge stocks, bonds, marketable securities, notes, fixed-income obligations, private capital, works of art, tangible personal property, real property, or other property accepted as collateral in the lending industry. However, if it is desired to keep the amount of encumbered assets to a minimum, the transferor 13 may also use its interest in the insurance policy 20 or the SPIA as collateral. The transferor 13 may also secure the loan by creating a financial instrument known as a “buy-sell agreement.” The buy-sell agreement 27, as illustrated in FIG. 14, may be structured so that, at the death of the insured, the transferor 13 or the transferor's estate would obtain the right to force the transferee 15 to purchase assets held by the transferor 13 or the transferor's estate up to a specified amount such as, but not limited to, the amount of death benefit proceeds received by the transferee 15 or the amount of any outstanding loan principal. The buy-sell agreement 27 may also obligate the transferee 15 to use the death benefit proceeds it may receive to fund the purchase, thereby ensuring the availability of sufficient funds for the transferor 13 or the transferor's estate to pay back the loan principal to the lender company 21. One of ordinary skill in the art should recognize that the buy-sell agreement 27 may enable the transferor 13 to satisfy the collateral requirements of the lender company 21, even when the rights possessed by the transferor 13 with respect to the insurance policy 20 during the split-dollar agreement 19 is terminated. Stated differently, the buy-sell agreement 27 may enable a party having no formal ownership interest in a policy to pledge it, in effect, as collateral for a loan taken out by that party.

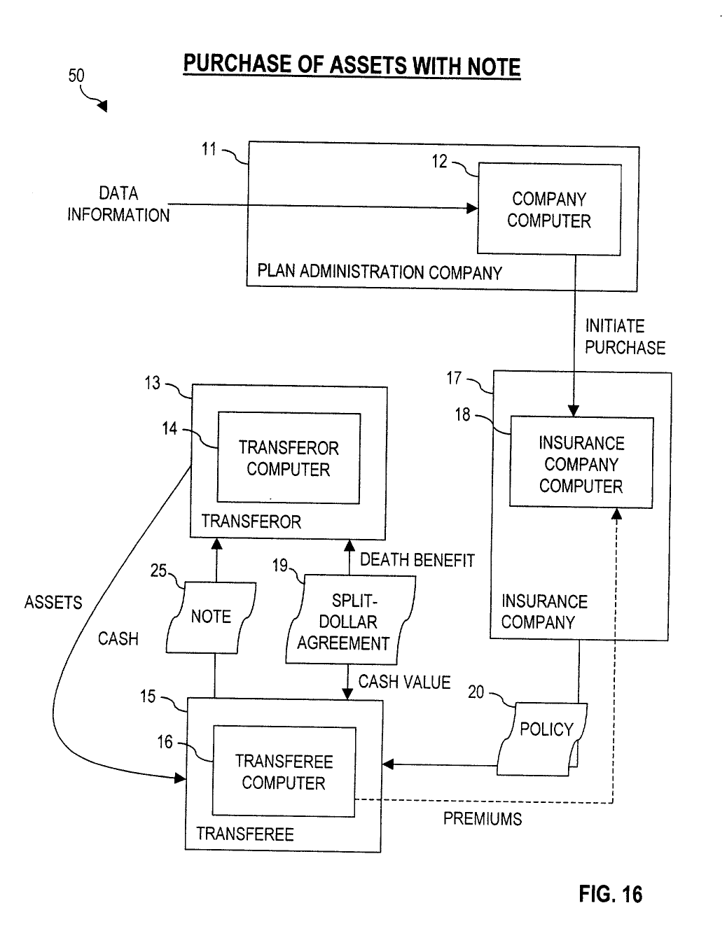

With regard to the specific form of payment made by the transferor 13 for the rights to the death benefit components in the above embodiments, payments can be made in the form of, but not limited to, cash, assets, stocks, bonds, marketable securities, notes, assumed debts, redemptions or write-downs of notes, partnership units, closely-held business interests, private capital, works of art, tangible personal property, real property, intellectual property, or any other valuable interest or consideration. So long as sufficient liquidity is available to the transferee 15 to satisfy its actual premium obligations to the insurance company 17, the balance of the rent payments may be made in any of the aforementioned manners. In one variation of the above embodiments, the lifetime transfer of non-liquid wealth may be facilitated through a purchase of the assets by the transferee 15 in exchange for a note. As illustrated in FIG. 16, there is shown a block diagram of a system 50 for implementing and/or administering one aspect of a wealth transfer plan involving a lifetime purchase of assets in return for a note. Referring to FIG. 16, the transferor 13 may transfer assets to the transferee 15 during the lifetime of the insured. The transferor 13 may also transfer sufficient cash for the transferee 15 to pay the premiums of the life insurance policy. In exchange for the assets and cash, the transferee 15 may issue a note 25 to the transferor 13. Each time the transferor 13 makes a rent payment to the transferee 15 for the rights to the death benefit component of the policy 20, the transferee 15 may, in turn, use the payment proceeds to pay down the note or any interest due on the note. Alternatively, instead of making actual payments to the transferee 15, the transferor 13 may simply write down the note 25 by the amount of the rent payments as specified in the split-dollar agreement 19 until the note 25 is fully repaid. It should be appreciated that this embodiment may enable the transferor 13 to accomplish the immediate transfer of assets during the lifetime of the insured in return for a gradual repayment over time. One advantage to such an immediate transfer is that, in the case of an appreciating asset, any post-transfer appreciation would occur outside of the possession of the transferor 13 and may not be includable in his or her estate for federal estate tax purposes.

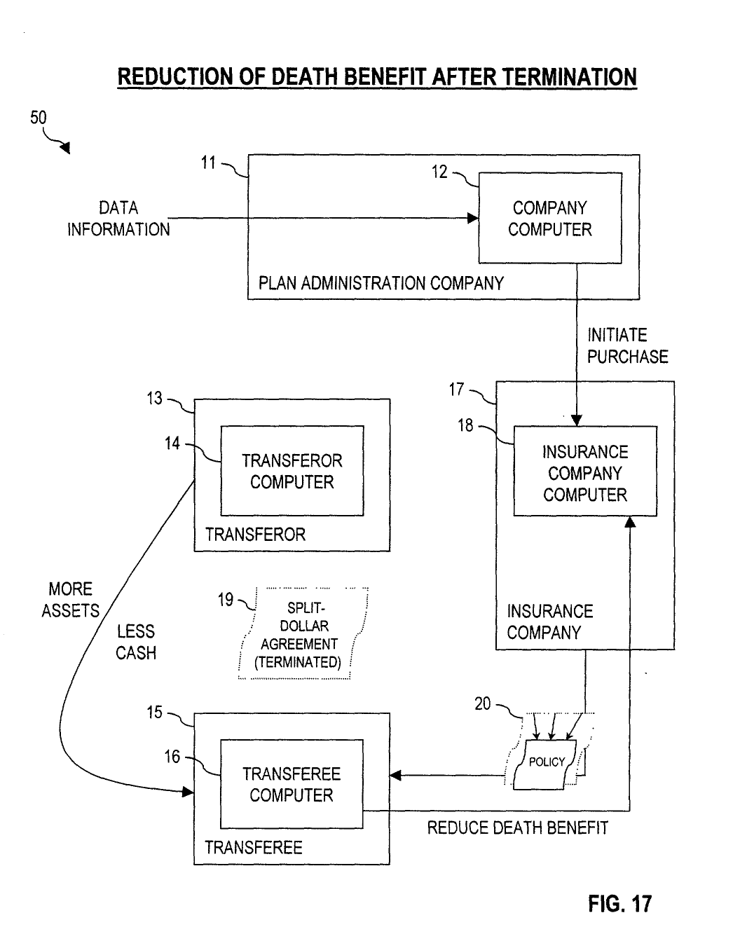

To further facilitate the transfer of assets, the transferor 13 may reduce the face amount of the policy 20 after the termination of the split-dollar agreement 19. As illustrated in FIG. 17, there is shown a block diagram of a system 50 for implementing and/or administering one aspect of a wealth transfer plan involving a reduction of the face amount of the policy 20. After the termination of the split-dollar agreement 19, the transferee 15 may reduce the face amount to a lower amount or even cancel the policy 20. To this end, the transferee computer 16 may transmit a message to the insurance company computer 18 requesting the reduction of the face amount of the policy 20. In response, the insurance company 17 may reduce the face amount. Consequently, the amount of premiums paid by the transferee 15 (and the cash transferred from the transferor 13) may be reduced while still keeping the policy 20 in force through the life of the insured. This, in turn, may enable the transferor 13 to increase the ratio of assets to cash in the wealth transferred to the transferee 15.

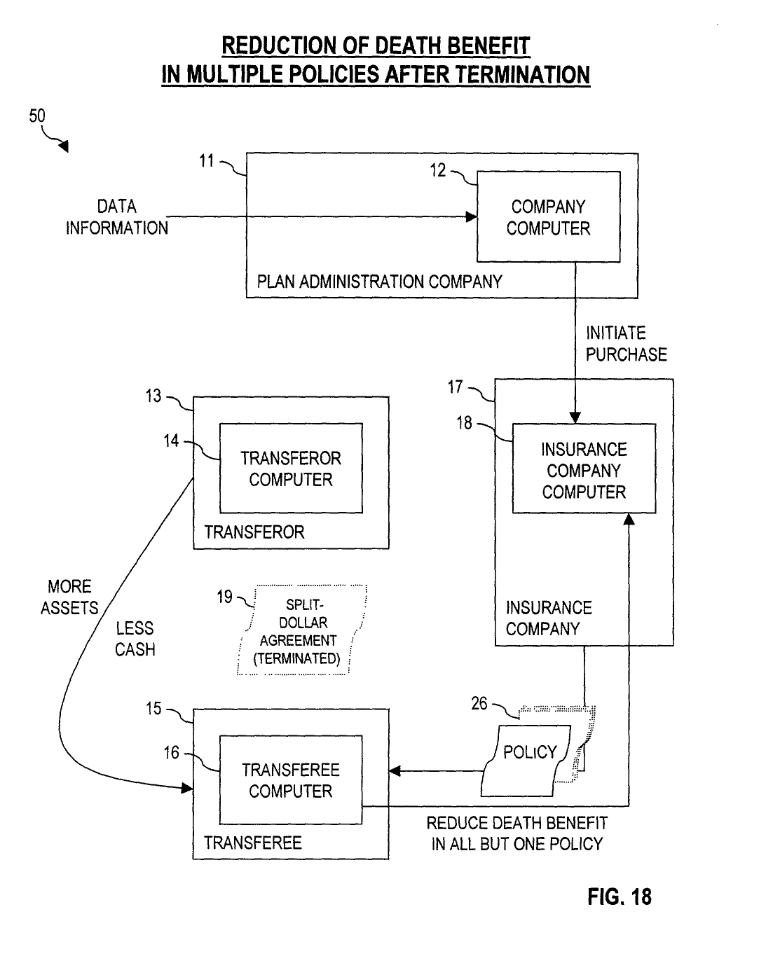

A variation to this approach, as shown in FIG. 18, involves the purchase of multiple policies 26 by the transferee 15. After the split-dollar agreement 19 is terminated, the transferee 15 may reduce the face amount in at least one of the multiple policies 26 or cancel at least one of the multiple policies 26. For instance, in one embodiment, the transferee 15 may reduce to zero the face amounts in all but one policy. To this end, the transferee computer 16 may transmit a message to the insurance company computer 18 requesting the reduction of the face amounts. In response, the insurance company 17 may make the requested reduction, thereby decreasing the amount of premiums necessary to keep the remaining policy in force through the life of the insured. Hence, the transferor 13 may be able to increase the ratio of assets to cash in the wealth transferred to the transferee 15. It should be understood by one of ordinary skill in the art that although the above embodiments involve the reduction of face amounts after the termination of the split-dollar agreement, the reduction may also be made while the split-dollar agreement is still in effect, so long as the policy is sufficiently funded. It should also be understood that the aspects of a lifetime transfer of assets in exchange for a note and a reduction of the face amounts in one or more policies may either or both be used in conjunction with all other embodiments and aspects disclosed before or hereinafter.

While the above embodiments may facilitate the transfer of wealth in a cost-effective manner with minimal liquidity requirements and lifetime cost, in the case where the loan has a floating interest rate, the transferor 13 may face potential exposure in the event of a significant rise in interest rates. The transferor 13 may reduce the potential risks by establishing an upper limit for the interest rate. This can be done by setting forth a provision in the loan agreement establishing a “cap” on the interest rate, limiting how much interest rates may increase in a single adjustment period in exchange for a premium. The transferor 13 may also establish an upper limit by purchasing a security known as an “interest rate collar.” An interest rate collar typically combines the purchase of a “cap” and the sale of a “floor” to specify a range in which an interest rate will fluctuate. Although the collar limits the benefits to the purchaser if the loan interest rates drop, such a security insulates the purchaser against the risk of significant rises in the interest rates. The transferor 13 may also reduce potential risks created by fluctuating interest rates by entering into an “interest rate swap,” a deal between two parties in which a floating rate loan is exchanged for a fixed rate loan, or obtain any kind of derivative product that has the same cumulative effect. It should be appreciated by one of ordinary skill in the art that any of the above derivative products for setting an upper limit on interest rates may be used in conjunction with any of the embodiments involving a loan disclosed before or hereinafter.

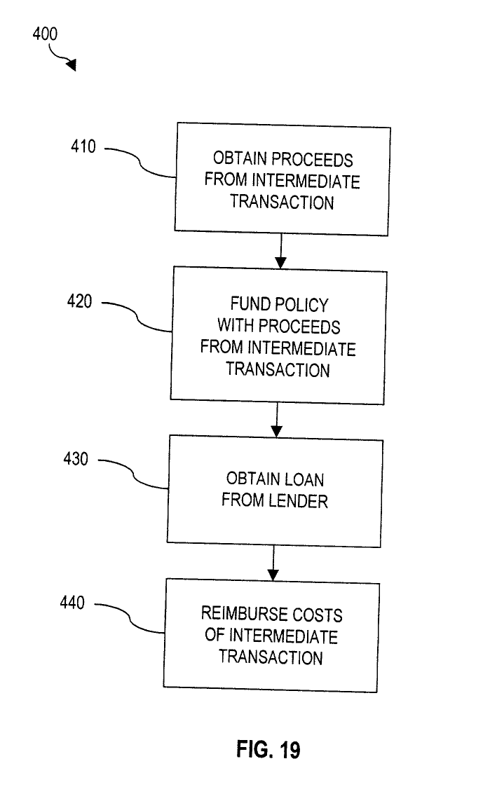

It should also be understood that “loan financing” as used above and hereinafter is intended to not only include embodiments where the proceeds from the loan are used to directly fund a life insurance policy, but also embodiments in which the proceeds from the loan are used to indirectly fund a life insurance policy. As illustrated in FIG. 19, there is shown a flow chart depicting a method 400 according to which a transferor 13 may fund a life insurance policy indirectly with proceeds from a loan. The method 400 includes obtaining proceeds from an intermediate transaction (block 410); funding a life insurance policy with the proceeds from the intermediate transaction (block 420); obtaining a loan from a lender (block 430); and using the proceeds from the loan to reimburse the costs of the intermediate transaction (block 440). In the above embodiments, the intermediate transaction may be an income-forwarding sales transaction (i.e., a short sale, a pre-paid forward sale, and other transactions that provides sale proceeds in advance available through financial institutions such as investment banks), a sale of securities, a maturity of bonds, a liquidation of assets, a depletion of a capital account, or the like, or any combination of the above. In such cases, the proceeds from the loan are used to cover the position taken in the income-forwarding sales transaction, repurchase the sold securities, replace the matured bonds, recover the liquidated assets, replenish the capital account, or otherwise reimburse the costs of funding the insurance policy through single or multiple intermediate transactions. Since the proceeds from the loan indirectly fund the life insurance policy, it is intended that “loan proceed,” as used above and hereinafter, would further encompass the proceeds used in the above embodiments to fund the life insurance policy, notwithstanding the fact that the proceeds may have come directly from an intermediate transaction. Similarly, it is also intended that “sale proceed,” as used above and hereinafter, would further encompass proceeds used to actually find a life insurance policy, notwithstanding the fact that the proceeds may only indirectly derive from an income-forwarding sales transaction. Advantages to such embodiments may include further reductions in the overall cost of the wealth transfer plan. For instance, subject to rules promulgated by the government, such embodiments may generate deductible capital investment interest for the transferor 13 on the loan. This capital investment interest may be used to offset investment income that the transferor 13 may possess, thereby reducing potential income tax liability.

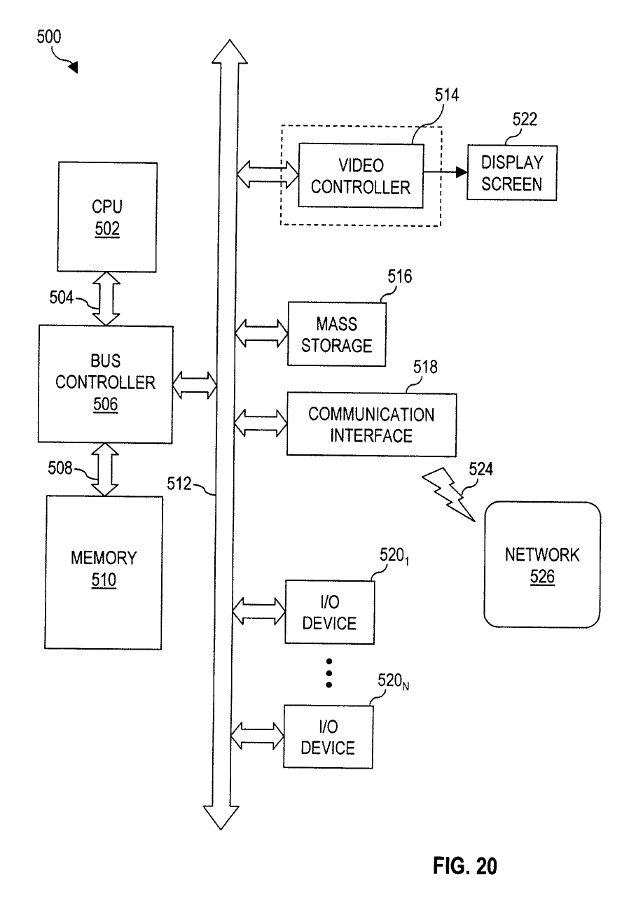

In the foregoing description, the company computer 12, the transferor computer 14, the transferee computer 16, the insurance company computer 18, the lender company computer 22, and the SPIA company computer 24, may all be devices including circuitry capable of processing data. A description of an exemplary computer is herein described. Referring to FIG. 20, the computer 500 comprises a processor or a central processing unit (CPU) 502. The illustrated CPU 502 includes an Arithmetic Logic Unit (ALU) for performing computations, a collection of registers for temporary storage of data and instructions, and a control unit for controlling operation for the computer 500. The CPU 502 may be a microprocessor, a microcontroller, a digital signal processor, a reduced instruction set computer (RISC), an application specific integrated circuits, and the like. Although shown with one CPU 502, computer 500 may alternatively include multiple processing units.

The CPU 502 is coupled to a bus controller 506 by way of a CPU bus 504. Bus controller 506 provides an interface between the CPU 502 and memory 510 via memory bus 508. Moreover, bus controller 506 provides an interface between memory 510, CPU 502 and other devices coupled to system bus 512. It should be appreciated that memory 510 may be system memory, such as synchronous dynamic random access memory (SDRAM) or may be another form of volatile memory. It should further be appreciated that memory 510 may include nonvolatile memory, such as ROM or flash memory. The system bus 512 may be a peripheral component interconnect (PCI) bus, Industry Standard Architecture (ISA) bus, etc. Coupled to the system bus 512 are a video controller 514, a mass storage device 516, a communication interface device 518, and one or more input/output (I/O) devices 520₁-520_{N}. The video controller 514 controls display data for displaying information on the display screen 522. In another embodiment, the video controller 514 is coupled to the CPU 502 through an Advanced Graphics Port (AGP) bus.

The mass storage device 516 includes, but is not limited to, a hard disk, floppy disk, CD-ROM, DVD-ROM, tape, high-density floppy, high-capacity removable media, low-capacity removable media, solid-state memory device, and the like. The mass storage device 516 may include any other mass storage medium. The communication interface device 518 includes a network card, a modem interface, etc. for accessing network 526 via communications link 524. The communication link 524 may be a medium or channel of communication including, but not limited to, a telephone line, a modem connection, an Internet connection, an Integrated Services Digital Network (ISDN) connection, an Asynchronous Transfer Mode (ATM) connection, a Digital Subscriber Line (DSL) connection, a TCP/IP connection, a frame relay connection, an Ethernet connection, a coaxial connection, a fiber-optic connection, satellite connections, wireless connections, radio frequency (RF) links, electromagnetic links, two-way paging connections, etc. and any combination thereof. The network 526 may include a local area network (LAN), a wide area network (WAN), a worldwide area network, such as the Internet or the World Wide Web, an Intranet, or any combination thereof.

The I/O devices 520₁-520_{N} may include a keyboard, mouse, trackball, voice recognition device, light pen, 3D sensor, scanner, audio/sound card, LCD or CRT monitors, printer, plotter, fax, and the like. The I/O devices 520₁-520_{N} may also include disk drives, such as compact disk drives, digital disk drives, tape drives, magnetic storage drives, digital video disk (DVD) drives, laser disk drives, magneto-optical disk drives, high density floppy drives, high-capacity removable media drives, low-capacity media devices, and any combination thereof.

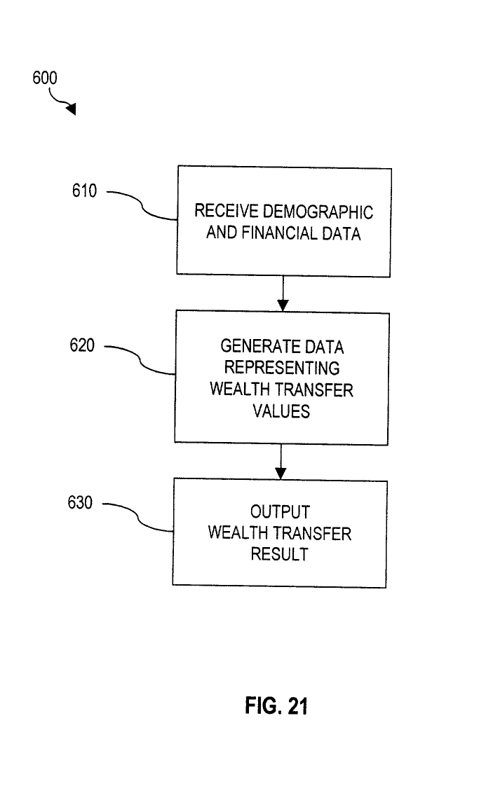

Preferably, the computer 500 further includes an operating system (OS) and at least one application program, which in one embodiment, is loaded into memory 510 from mass storage device 516 and launched after Power On Self Test (POST). The operating system is a set of one or more programs, which control the computer system's operation and the allocation of resources. The application program may be a set of one or more software programs that performs a task desired by the user, such as sending messages and fund transfers from one computer to another over the network 526. The application program may also be a set of one or more software programs that computes data to generate wealth transfer outputs for the implementation and/or administration of the wealth transfer plan. As illustrated in FIG. 21, there is shown a flow chart depicting a method 600 according to which the application program may compute data to generate wealth transfer outputs for the implementation and/or administration of the wealth transfer plan. The method 600 includes receiving data representing demographic and financial information (block 610), generating data representing values related to the steps or transactions of a wealth transfer plan (block 620), and outputting a wealth transfer result in the form of values, figures, spreadsheets, or illustrations (block 630). The generated data may be outputted on the display screen 522 or by one or more I/O devices 520₁-520_{N}, and may include, but are not limited to, values representing insurance premiums, annuity premiums, loans, assets, interest expense, annuity income, cash flow, economic benefit, taxes, cash value, premiums paid, total death benefit, net death benefit, net wealth transfer results, and the like. It should be understood that the output of the application program may be used for marketing and sales purposes, as well as for the proper implementation and administration of the wealth transfer plan.

In summary, the disclosed apparatus and method provide for the implementation and/or administration of a cost-effective wealth transfer plan. The plan may involve various combinations of components including life insurance policies, split-dollar agreements, loan financing, income-generating investment instruments, buy-sell agreements, exchanges of assets for notes, derivative products, and intermediate transactions. With some or all of the components combined, this strategy may achieve substantial wealth transfer at substantial savings in costs and taxes. While certain exemplary embodiments have been described herein and illustrated in the accompanying drawings, it is to be understood that such embodiments are merely illustrative of and not restrictive on the broad invention. It is also to be understood that this invention is not to be limited to the specific constructions and arrangements shown and described, since various other modifications within the scope of the present disclosure may occur to those of ordinary skill in the art.

What is claimed is:

1. A method for implementing and/or administering a wealth transfer plan, comprising:
obtaining loan financing through a loan having a principal and an interest, said loan producing a loan proceed;
obtaining an income-generating investment instrument with said loan proceed, said income-generating investment instrument producing a periodic income;
paying said interest of said loan with said periodic income;
securing an insurance policy on the life of an insured, said insurance policy having a death benefit component, a cash value component, and a death benefit proceed to be paid out at the death of said insured;
allocating rights to said death benefit component to a transferor and allocating rights to said cash value component to a transferee; and
transferring wealth from said transferor as payment for said rights to said death benefit component, wherein at least some of said wealth is said loan proceed.

2. The method according to claim 1, further comprising:
consolidating said rights to said death benefit component and said rights to said cash value component in said transferee after said wealth is transferred.

3. The method according to claim 1, wherein said loan is an interest-only, non-callable loan.

4. The method according to claim 1, wherein said income-generating investment instrument is a single premium immediate annuity.

5. The method according to claim 1, wherein at least some of said wealth is said periodic income.

6. The method according to claim 1, further comprising:
generating a buy-sell agreement, said buy-sell agreement between said transferor and said transferee structured to secure availability of said death benefit proceed to pay said principal of said loan.

7. The method according to claim 1, further comprising:
transferring assets from said transferor to said transferee in return for a note, said note to be reduced by said payment for said rights to said death benefit component.

8. The method according to claim 1, further comprising:
obtaining a derivative product, said derivative product establishing an upper limit to the rate of said interest.

9. The method according to claim 1, further comprising:
reducing amount of said death benefit proceed of said insurance policy to facilitate transfer of assets.

10. The method according to claim 1, further comprising:
calculating amount of said wealth based on life insurance valuation tables.

11. The method according to claim 1, wherein said insurance policy or said income-generating investment instrument is pledged as collateral for said loan.

12. A system for implementing and/or administering a wealth transfer plan, comprising:
an insurance policy having a death benefit component and a cash value component, said insurance policy provided by an insurer and secured by a transferee, and said insurance policy paying a death benefit proceed at the death of an insured;
a loan having a principal and an interest, said loan provided by a lender and obtained by a transferor, said loan providing a loan proceed, and said principal to be paid with said death benefit proceed from said insurance policy;
an income-generating investment instrument producing a periodic income, said income-generating investment instrument obtained with said loan proceed, and said periodic income to pay said interest; and
a split-dollar agreement providing that rights to said death benefit component be allocated to said transferor, that rights to said cash value component be allocated to said transferee, and that said transferor transfer wealth as payment for said rights to said death benefit component wherein at least some of said wealth is said loan proceed.

13. The system according to claim 12, wherein said rights to said death benefit component and said rights to said cash value component are to be consolidated in said transferee after said wealth is transferred.

14. The system according to claim 12, wherein said loan is an interest-only, non-callable loan.

15. The system according to claim 12, wherein said income-generating investment instrument is a single premium immediate annuity.

16. The system according to claim 12, wherein at least some of said wealth is said periodic income.

17. The system according to claim 12, further comprising:
a buy-sell agreement, said buy-sell agreement between said transferor and said transferee structured to secure availability of said death benefit proceed to pay said principal of said loan.

18. The system according to claim 12, further comprising:
a note issued from said transferee to said transferor in exchange for assets, said note to be reduced pursuant to said split-dollar agreement by said payment for said rights to said death benefit component.

19. The system according to claim 12, further comprising:
a derivative product, said derivative product establishing an upper limit to the rate of said interest.

20. The system according to claim 12, wherein said death benefit proceed of said insurance policy is reduced to facilitate transfer of assets.

21. The system according to claim 12, wherein said split-dollar agreement identifies a life insurance valuation table based upon which said wealth is to be calculated.

22. The method according to claim 12, wherein said insurance policy or said income-generating investment instrument is pledged as collateral for said loan.

23. A system for implementing and/or administering a wealth transfer plan, comprising:
means for obtaining loan financing through a loan having a principal and an interest, said loan producing a loan proceed;
means for obtaining an income-generating investment instrument with said loan proceed, said income-generating investment instrument producing a periodic income;
means for paying said interest of said loan with said periodic income;
means for securing an insurance policy on the life of an insured, said insurance policy having a death benefit component and a cash value component, and a death benefit proceed to be paid out at the death of said insured;
means for allocating rights to said death benefit component to a transferor and allocating rights to said cash value component to a transferee; and
means for transferring wealth from said transferor as payment for said rights to said death benefit component, wherein at least some of said wealth is said loan proceed.

24. The system according to claim 23, further comprising:
means for consolidating said rights to said death benefit component and said rights to said cash value component in said transferee after said wealth is transferred.

25. The system according to claim 23, wherein said loan is an interest-only, non-callable loan.

26. The system according to claim 23, wherein said income-generating investment instrument is a single premium immediate annuity.

27. The system according to claim 23, wherein at least some of said wealth is said periodic income.

28. The system according to claim 23, further comprising:
means for generating a buy-sell agreement, said buy-sell agreement between said transferor and said transferee structured to secure availability of said death benefit proceed to pay said principal of said loan.

29. The system according to claim 23, further comprising:
means for transferring assets from said transferor to said transferee in return for a note, said note to be reduced by said payment for said rights to said death benefit component.

30. The system according to claim 23, further comprising:
means for obtaining a derivative product, said derivative product establishing an upper limit to the rate of said interest.

31. The system according to claim 23, further comprising:
means for reducing said death benefit proceed of said insurance policy to facilitate transfer of assets.

32. The system according to claim 23, further comprising:
means for calculating amount of said wealth based on life insurance valuation tables.

33. The system according to claim 23, wherein said insurance policy or said income-generating investment instrument is pledged as collateral for said loan.

34. A data processing system for use in the implementation and/or administration of a wealth transfer plan, comprising:
an input device,
a CPU, coupled to said input device, said CPU generating
(i) data representing a loan having a principal and an interest;
(ii) data representing an insurance policy, said insurance policy having a death benefit component and a cash value component, and said insurance policy to pay a death benefit proceed at the death of an insured;
(iii) data representing an income-generating investment instrument funded with said loan, said income-generating investment instrument producing a periodic income;
(iv) data representing a payment of said interest of said loan with said periodic income;
(v) data representing the allocation of rights to said death benefit component to a transferor and allocation of rights to said cash value component to a transferee;
(vi) data representing wealth transferred from said transferor as payment for said rights to said death benefit component;
(vii) data representing a payment of said principal with said death benefit proceed; and
an output device, coupled to said CPU, to output said data representing wealth transferred from said transferor.

35. The system according to claim 34, further comprising:
said CPU generating
(viii) data representing a consolidation of said rights to said death benefit component and said rights to said cash value component in said transferee after said wealth is transferred.

36. The system according to claim 34, wherein said loan is an interest-only, non-callable loan.

37. The system according to claim 34, wherein said income-generating investment instrument is a single premium immediate annuity.

38. The system according to claim 34, wherein at least some of said wealth is said periodic income.

39. The system according to claim 34, further comprising:
said CPU generating
(viii) data representing assets transferred from said transferor to said transferee in return for a note, said note to be reduced by said payment for said rights to said death benefit component.

40. The system according to claim 34, further comprising:
said CPU generating
(viii) data representing a derivative product, said derivative product establishing an upper limit to the rate of said interest.

41. The system according to claim 34, further comprising:
said CPU generating
(viii) data representing a reduction of said death benefit proceed of said insurance policy to facilitate transfer of assets.

42. The system according to claim 34, further comprising:
said CPU generating
(viii) data representing amount of said wealth calculated based on life insurance valuation tables.

43. A computer program product for use in the implementation and/or administration of a wealth transfer plan, said computer program product comprising:
a computer usable medium having a computer readable program code embodied in said medium for causing a computer to:
generate data representing a loan having a principal and an interest;
generate data representing an insurance policy, said insurance policy having a death benefit component and a cash value component, and said insurance policy to pay a death benefit proceed at the death of an insured;
generate data representing an income-generating investment instrument funded with said loan, said income-generating investment instrument producing a periodic income;
generate data representing a payment of said interest of said loan with said periodic income;
generate data representing the allocation of rights to said death benefit component to a transferor and allocation of rights to said cash value component to a transferee;
generate data representing wealth transferred from said transferor as payment for said rights to said death benefit component; and
generate data representing a payment of said principal with said death benefit proceed.

44. The computer program product according to claim 43, wherein said computer readable program code further causes said computer to:
generate data representing a consolidation of said rights to said death benefit component and rights to said cash value component in said transferee.

45. The computer program product according to claim 43, wherein said loan is an interest-only, non-callable loan.

46. The computer program product according to claim 43, wherein said income-generating investment instrument is a single premium immediate annuity.

47 The computer program product according to claim 43, wherein at least some of said wealth is said periodic income.

48. The computer program product according to claim 43, wherein said computer readable program code further causes said computer to:
generate data representing assets transferred from said transferor to said transferee in return for a note, said note to be reduced by said payment for said rights to said death benefit component.

49. The computer program product according to claim 43, wherein said computer readable program code further causes said computer to:
generate data representing a derivative product, said derivative product establishing an upper limit to the rate of said interest.

50. The computer program product according to claim 43, wherein said computer readable program code further causes said computer to:
generate data representing a reduction of said death benefit proceed of said insurance policy to facilitate transfer of assets.

51. The computer program product according to claim 43, wherein said computer readable program code further causes said computer to:
generate data representing amount of said wealth calculated based on life insurance valuation tables.

52. A method for financing the purchase of life insurance, comprising:
obtaining loan financing through a loan having a principal and an interest, said loan producing a loan proceed;
obtaining an income-generating investment instrument with said loan proceed, said income-generating investment instrument producing a periodic income;
paying said interest of said loan with said periodic income;
securing an insurance policy on the life of an insured, said insurance policy having a death benefit component and a cash value component, and a death benefit proceed to be paid out at the death of said insured; and
funding said insurance policy with said loan proceed.

53. The method according to claim 52, further comprising:
funding said insurance policy with said periodic income.

54. The method according to claim 53, wherein said income-generating investment instrument is a single premium immediate annuity.

55. The method according to claim 52, further comprising:
obtaining a derivative product, said derivative product establishing an upper limit to the rate of said interest.

56. The method according to claim 52, further comprising:
generating a buy-sell agreement, said buy-sell agreement structured to secure availability of said death benefit proceed to pay said principal of said loan.

57. The method according to claim 52, wherein said loan is an interest-only, non-callable loan.

58. The method according to claim 52, wherein said income-generating investment instrument is a single premium immediate annuity.

59. The method according to claim 52, wherein said insurance policy or said income-generating investment instrument is pledged as collateral for said loan.

60. A system for financing the purchase of life insurance, comprising:
an insurance policy having a death benefit component and a cash value component, said insurance policy provided by an insurer and secured by a policy holder, and said insurance policy to pay a death benefit proceed at the death of an insured;
a loan having a principal and an interest, said loan provided by a lender and obtained by said policy holder, said loan producing a loan proceed used to fund said insurance policy, said principal to be paid with said death benefit proceed from said insurance policy; and
an income-generating investment instrument producing a periodic income, said income-generating investment instrument obtained with said loan proceed, and said periodic income paying said interest.

61. The system according to claim 60, wherein said insurance policy is funded at least partially with said periodic income.

62. The system according to claim 61, wherein said income-generating investment instrument is a single premium immediate annuity.

63. The system according to claim 60, further comprising:
a derivative product, said derivative product establishing an upper limit to the rate of said interest.

64. The system according to claim 60, further comprising:
a buy-sell agreement, said buy-sell agreement structured to secure availability of said death benefit proceed to pay said principal of said loan.

65. The system according to claim 60, wherein said loan is an interest-only, non-callable loan.

66. The system according to claim 60, wherein said income-generating investment instrument is a single premium immediate annuity.

67. The system according to claim 60, wherein said insurance policy or said income-generating investment instrument is pledged as collateral for said loan.

68. A system for financing the purchase of life insurance, comprising:
means for obtaining loan financing through a loan having a principal and an interest, said loan producing a loan proceed;
means for obtaining an income-generating investment instrument with said loan proceed, said income-generating investment instrument producing a periodic income;
means for paying said interest of said loan with said periodic income;
means for securing an insurance policy on the life of an insured, said insurance policy having a death benefit component and a cash value component, and a death benefit proceed to be paid out at the death of said insured; and
means for funding said insurance policy with said loan proceed.

69. The system according to claim 68, further comprising:
means for funding said insurance policy with said periodic income.

70. The system according to claim 69, wherein said income-generating investment instrument is a single premium immediate annuity.

71. The system according to claim 68, further comprising:
means for obtaining a derivative product, said derivative product establishing an upper limit to the rate of said interest.

72. The system according to claim 68, further comprising:
means for generating a buy-sell agreement, said buy-sell agreement structured to secure availability of said death benefit proceed to pay said principal of said loan.

73. The system according to claim 68, wherein said loan is an interest-only, non-callable loan.

74. The system according to claim 68, wherein said income-generating investment instrument is a single premium immediate annuity.

75. The system according to claim 68, wherein said insurance policy or said income-generating investment instrument is pledged as collateral for said loan.

76. A data processing system for use in financing the purchase of life insurance, comprising:
an input device,
a CPU, coupled to said input device, said CPU generating
(i) data representing a loan having a principal and an interest, said loan producing a loan proceed;
(ii) data representing an insurance policy having a death benefit component and a cash value component, said insurance policy funded with said loan proceed, and said insurance policy to pay a death benefit proceed at the death of an insured;
(iii) data representing an income-generating investment instrument funded with said loan proceed, said income-generating investment instrument producing a periodic income;
(iv) data representing a payment of said interest of said loan with said periodic income;
(v) data representing a payment of said principal with said death benefit proceed;
(vi) data representing a result of financing said purchase of said insurance policy; and
an output device, coupled to said CPU, to output said result of financing said purchase of said insurance policy.

77. The system according to claim 76, wherein said insurance policy is at least partially funded with said periodic income.

78. The system according to claim 77, wherein said income-generating investment instrument is a single premium immediate annuity.

79. The system according to claim 76, further comprising:
said CPU generating
(vii) data representing a derivative product, said derivative product establishing an upper limit to the rate of said interest.

80. The system according to claim 76, wherein said loan is an interest-only, non-callable loan.

81. The system according to claim 76, wherein said income-generating investment instrument is a single premium immediate annuity.

82. A computer program product for use in financing the purchase of life insurance, said computer program product comprising:
a computer usable medium having a computer readable program code embodied in said medium for causing a computer to:
generate data representing a loan having a principal and an interest, said loan producing a loan proceed;
generate data representing an insurance policy having a death benefit component and a cash value component, said insurance policy funded with said loan proceed;
generate data representing an income-generating investment instrument funded with said loan proceed, said income-generating investment instrument producing a periodic income;
generate data representing a payment of said interest of said loan with said periodic income; and
generate data representing a payment of said principal with said death benefit proceed.

83. The computer program product according to claim 82, wherein said insurance policy is at least partially funded with said periodic income.

84. The computer program product according to claim 83, wherein said income-generating investment instrument is a single premium immediate annuity.

85. The computer program product according to claim 82, wherein said computer readable program code further causes said computer to:
generate data representing a derivative product, said derivative product establishing an upper limit to the rate of said interest.

86. The computer program product according to claim 82, wherein said loan is an interest-only, non-callable loan.

87. The computer program product according to claim 82, wherein said income-generating investment instrument is a single premium immediate annuity.

88. A method for transferring wealth, comprising:
securing an insurance policy on the life of an insured, said insurance policy having a death benefit component and a cash value component, and said insurance policy to pay a death benefit proceed at the death of said insured;
allocating rights to said death benefit component to a transferor and allocating rights to said cash value component to a transferee;
transferring assets from said transferor to said transferee in return for a note; and
reducing said note by said transferor through payment for said rights to said death benefit component.

89. The method according to claim 88, further comprising:
consolidating said rights to said death benefit component and said rights to said cash value component in said transferee.

90. The method according to claim 88, further comprising:
reducing said death benefit proceed of said insurance policy to facilitate transfer of said assets.

91. The method according to claim 88, further comprising:
calculating amount of said payment based on life insurance valuation tables.

92. A system for transferring wealth, comprising:
an insurance policy having a death benefit component and a cash value component, said insurance policy provided by an insurer and secured by a transferee, and said insurance policy to pay a death benefit proceed at the death of an insured;
a split-dollar agreement providing that rights to said death benefit component be allocated to a transferor, that rights to said cash value components be allocated to said transferee, and that said transferor make payment for said rights to said death benefit component; and
a note issued from said transferee to said transferor in return for transferred assets, said note to be reduced by said payment for said rights to said death benefit component.

93. The system according to claim 92, wherein said rights to said death benefit component and said rights to said cash value component are to be consolidated in said transferee after said note is reduced by said payment.

94. The system according to claim 92, wherein said death benefit proceed of said insurance policy is to be reduced to facilitate transfer of said assets.

95. The system according to claim 92, wherein said split-dollar agreement further identifies a life insurance valuation table based upon which the amount of said assets is to be calculated.

96. A system for transferring wealth, comprising:
means for securing an insurance policy on the life of an insured, said insurance policy having a death benefit component and a cash value component, and said insurance policy to pay a death benefit proceed at the death of said insured;
means for allocating rights to said death benefit component to a transferor and allocating rights to said cash value component to a transferee;
means for transferring assets from said transferor to said transferee in return for a note; and
means for reducing said note by said transferor through payment for said rights to said death benefit component.

97. The system according to claim 96, further comprising:
means for consolidating said rights to said death benefit component and said rights to said cash value component in said transferee.

98. The system according to claim 96, further comprising:
means for reducing said death benefit proceed of said insurance policy to facilitate transfer of said assets.

99. The system according to claim 96, further comprising:
means for calculating amount of said payment based on life insurance valuation tables.

100. A data processing system for use in transferring wealth, comprising:
an input device,
a CPU, coupled to said input device, said CPU generating
(i) data representing an insurance policy, said insurance policy having a death benefit component and a cash value component, and said insurance policy to pay a death benefit proceed at the death of an insured;
(ii) data representing the allocation of rights to said death benefit component to a transferor and allocation of rights to said cash value component to a transferee;
(iii) data representing a payment for said rights to said death benefit component from said transferor;
(iv) data representing assets transferred from said transferor to said transferee in return for a note, said note to be reduced by said payment for said rights to said death benefit component; and
an output device, coupled to said CPU, to output said data representing said assets transferred.

101. The system according to claim 100, further comprising:
said CPU generating
(v) data representing a consolidation of said rights to said death benefit component and said rights to said cash value component in said transferee.

102. The system according to claim 100, further comprising:
said CPU generating
(v) data representing a reduction of said death benefit proceed of said insurance policy to facilitate transfer of assets.

103. The system according to claim 100, wherein said payment is calculated based on life insurance valuation tables.

104. A computer program product for use in transferring wealth, said computer program product comprising:
a computer usable medium having a computer readable program code embodied in said medium for causing a computer to:
generate data representing an insurance policy, said insurance policy having a death benefit component and a cash value component, and said insurance policy to pay a death benefit proceed at the death of an insured;
generate data representing the allocation of rights to said death benefit component to a transferor and allocation of rights to said cash value component to a transferee;
generate data representing a payment for said rights to said death benefit component from said transferor; and
generate data representing assets transferred from said transferor to said transferee in return for a note, said note to be reduced by said payment for said rights to said death benefit component.

105. The computer program product according to claim 104, wherein said computer readable program code further causes said computer to:
generate data representing a consolidation of said rights to said death benefit component and said rights to said cash value component in said transferee.

106. The computer program product according to claim 104, wherein said computer readable program code further causes said computer to:
generate data representing a reduction of said death benefit proceed of said insurance policy to facilitate transfer of assets.

107. The computer program product according to claim 104, wherein said payment is calculated based on life insurance valuation tables.

108. A method for financing the purchase of life insurance, comprising:
generating a sale proceed through an income-forwarding sales transaction;
funding an insurance policy with said sale proceed, said insurance policy to pay a death benefit proceed at the death of an insured;
obtaining a loan having a principal and an interest, said loan producing a loan proceed; and
covering a position taken in said income-forwarding sales transaction with said loan proceed.

109. The method according to claim 108, wherein said income-forwarding sales transaction is a short sale.

110. The method according to claim 108, wherein said income-forwarding sales transaction is a pre-p aid forward sale.

111. The method according to claim 108, further comprising:
investing said sale proceed in an income-generating investment instrument, said income-generating investment instrument producing a periodic income; and
paying said interest of said loan with said periodic income.

112. The method according to claim 111, further comprising:
funding said insurance policy with said periodic income.

113. The method according to claim 108, further comprising:
obtaining a derivative product, said derivative product establishing an upper limit to the rate of said interest.

114. The method according to claim 108, further comprising:
generating a buy-sell agreement, said buy-sell agreement structured to secure availability of said death benefit proceed to retire said loan.

115. The method according to claim 108, wherein said loan is an interest-only, non-callable loan.

116. The method according to claim 108, wherein said income-generating investment instrument is a single premium immediate annuity.

117. The method according to claim 108, wherein said insurance policy or said income-generating investment instrument is pledged as collateral for said loan.

118. A system for financing the purchase of life insurance, comprising:
an income-forwarding sales transaction generating a sale proceed for a policy holder,
an insurance policy having a death benefit proceed, said insurance policy provided by an insurer and secured by said policy holder with said sale proceed; and
a loan having a principal and an interest, said loan provided by a lender and obtained by said policy holder, said loan producing a loan proceed used to cover a position taken in said income-forwarding sales transaction.

119. The system according to claim 118, wherein said income-forwarding sales transaction is a short sale.

120. The system according to claim 118, wherein said income-forwarding sales transaction is a pre-paid forward sale.

121. The system according to claim 118, further comprising:
an income-generating investment instrument producing a periodic income, said income-generating investment instrument obtained with said loan proceed, and said periodic income paying said interest of said loan.

122. The system according to claim 121, wherein said insurance policy is funded at least partially with said periodic income.

123. The system according to claim 118, further comprising:
a derivative product, said derivative product establishing an upper limit to the rate of said interest.

124. The system according to claim 118, further comprising:
a buy-sell agreement, said buy-sell agreement structured to secure availability of said death benefit proceed to pay said principal of said loan.

125. The system according to claim 118, wherein said loan is an interest-only, non-callable loan.

126. The system according to claim 121, wherein said income-generating investment instrument is a single premium immediate annuity.

127. The system according to claim 118, wherein said insurance policy is pledged as collateral for said loan.

128. A system for financing the purchase of life insurance, comprising:
means for generating a sale proceed through an income-forwarding sales transaction;
means for funding an insurance policy with said sale proceed, said insurance policy having a death benefit proceed;
means for obtaining a loan having a principal and an interest, said loan producing a loan proceed; and
means for covering a position taken in said income-forwarding sales transaction with said loan proceed.

129. The system according to claim 128, wherein said income-forwarding sales transaction is a short sale.

130. The system according to claim 128, wherein said income-forwarding sales transaction is a pre-paid forward sale.

131. The system according to claim 128, further comprising:
means for investing said sale proceed in an income-generating investment instrument, said income-generating investment instrument producing a periodic income;
means for paying said interest of said loan with said periodic income;

132. The system according to claim 131, further comprising:
means for funding said insurance policy with said periodic income.

133. The system according to claim 128, further comprising:
means for obtaining a derivative product, said derivative product establishing an upper limit to the rate of said interest.

134. The system according to claim 128, further comprising:
means for generating a buy-sell agreement, said buy-sell agreement structured to secure availability of said death benefit proceed to retire said loan.

135. The system according to claim 128, wherein said loan is an interest-only, non-callable loan.

136. The system according to claim 128, wherein said income-generating investment instrument is a single premium immediate annuity.

137. The system according to claim 128, wherein said insurance policy or said income-generating investment instrument is pledged as collateral for said loan.

138. A data processing system for use in financing the purchase of life insurance, comprising:
an input device,
a CPU, coupled to said input device, said CPU generating
(i) data representing a sale proceed generated through an income-forwarding sales transaction;
(ii) data representing an insurance policy having a death benefit proceed, said insurance policy funded with said sale proceed;
(iii) data representing a loan having a principal and an interest, said loan producing a loan proceed;
(iv) data representing a covering of said income-forwarding sales transaction with said loan proceed;
(v) data representing a payment of said principal with said death benefit proceed;
(vi) data representing a result of deducting said interest for tax liability purposes; and
an output device, coupled to said CPU, to output said data representing said result.

139. The system according to claim 138, wherein said income-forwarding sales transaction is a short sale.

140. The system according to claim 138, wherein said income-forwarding sales transaction is a pre-paid forward sale.

141. The system according to claim 138, further comprising:
said CPU generating
(vii) data representing an income-generating investment instrument funded with said sale proceed, said income-generating investment instrument producing a periodic income; and
(viii) data representing a payment of said interest of said loan with said periodic income.

142. The system according to claim 138, wherein said insurance policy is at least partially funded with said periodic income.

143. The system according to claim 138, further comprising:
said CPU generating
(vii) data representing a derivative product, said derivative product establishing an upper limit to the rate of said interest.

144. The system according to claim 138, wherein said loan is an interest-only, non-callable loan.

145. The system according to claim 138, wherein said income-generating investment instrument is a single premium immediate annuity.

146. A computer program product for use in financing the purchase of life insurance, said computer program product comprising:
a computer usable medium having a computer readable program code embodied in said medium for causing a computer to:
generate data representing a sale proceed generated through an income-forwarding sales transaction;
generate data representing an insurance policy having a death benefit proceed, said insurance policy funded with said sale proceed;
generate data representing a loan having a principal and an interest, said loan producing a loan proceed;
generate data representing a covering of said income-forwarding sales transaction with said loan proceed;
generate data representing a payment of said principal with said death benefit proceed; and
generate data representing a result of deducting said interest for tax liability purposes.

147. The computer program product according to claim 146, wherein said income-forwarding sales transaction is a short sale.

148. The computer program product according to claim 146, wherein said income-forwarding sales transaction is a pre-paid forward sale.

149. The computer program product according to claim 146, wherein said computer readable program code further causes said computer to:
generate data representing an income-generating investment instrument funded with said sale proceed, said income-generating investment instrument producing a periodic income; and
generate data representing a payment of said interest of said loan with said periodic income.

150. The computer program product according to claim 146, wherein said insurance policy is at least partially funded with said periodic income.

151. The computer program product according to claim 146, wherein said computer readable program code further causes said computer to:
generate data representing a derivative product, said derivative product establishing an upper limit to the rate of said interest.

152. The computer program product according to claim 146, wherein said loan is an interest-only, non-callable loan.

153. The computer program product according to claim 146, wherein said income-generating investment instrument is a single premium immediate annuity.

154. A method for financing the purchase of life insurance, comprising:
securing an insurance policy having a death benefit proceed, said insurance policy owned by a first party;
executing a split-dollar agreement, said split-dollar agreement splitting rights to said insurance policy between said first party and a second party;
obtaining a loan by said second party, said loan generating a loan proceed;
funding said insurance policy with said loan proceed; and
generating a buy-sell agreement, said buy-sell agreement structured to secure availability of said death benefit proceed to retire said loan by granting said second party a right of first sale of assets to said first party.

155. The method according to claim 154, wherein said buy-sell agreement obligates said first party to use said death benefit proceed to purchase said assets.

156. The method according to claim 155, wherein said buy-sell agreement is pledged as collateral for said loan.

157. A system for financing the purchase of life insurance, comprising:
executing a split-dollar agreement, said split-dollar agreement splitting rights to said insurance policy between said first party and a second party;
an insurance policy having a death benefit proceed, said insurance policy owned by a first party;
a loan generating a loan proceed, said loan obtained by a second party, and said loan proceed funding said insurance policy; and
a buy-sell agreement, said buy-sell agreement structured to secure availability of said death benefit proceed to retire said loan by granting said second party a right of first sale of assets to said first party.

158. The system according to claim 157, wherein said buy-sell agreement obligates said second party to use said death benefit proceed to purchase said assets.

159. The method according to claim 158, wherein said buy-sell agreement is pledged as collateral for said loan.

160. A method for financing the purchase of life insurance, comprising:
means for securing an insurance policy having a death benefit proceed, said insurance policy owned by a first party;
means for executing a split-dollar agreement, said split-dollar agreement splitting rights to said insurance policy between said first party and a second party;
means for obtaining a loan by said second party, said loan generating a loan proceed;
means for funding said insurance policy with said loan proceed; and
means for generating a buy-sell agreement, said buy-sell agreement structured to secure availability of said death benefit proceed to retire said loan by granting said second party a right of first sale of assets to said first party.

161. The method according to claim 160, wherein said buy-sell agreement obligates said first party to use said death benefit proceed to purchase said assets.

162. The method according to claim 161, wherein said buy-sell agreement is pledged as collateral for said loan.
